(19) United States
(12) Patent Application Publication
(10) Pub. No.: US 2010/0220120 A1
(43) Pub. Date: Sep. 2, 2010

(54) LIGHT EMITTING DISPLAY PANEL

(75) Inventors: Mayumi Ozaki, Yonezawa-shi (JP); Katsuhiro Kanauchi, Yonezawa-shi (JP); Akinori Hayafuji, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo (JP)

(21) Appl. No.: 12/771,443

(22) Filed: Apr. 30, 2010

Related U.S. Application Data
(62) Division of application No. 11/546,533, filed on Oct. 12, 2006.

(30) Foreign Application Priority Data
Oct. 13, 2005 (JP) 2005-298315
Oct. 18, 2005 (JP) 2005-303445
Oct. 18, 2005 (JP) 2005-303446
Nov. 24, 2005 (JP) 2005-338724

(51) Int. Cl. G09G 5/10; G09G 3/32

(52) U.S. Cl. 345/690; 345/83

(57) ABSTRACT

A drive apparatus is provided which can calculate a suitable APL value when driving a color display panel using PLE control. Further, a drive apparatus is provided which can inhibit output capacity of a power supply circuit by controlling display brightness according to a lighting rate of a pixel. An APL calculation means 20 is provided with a weighting means 22A for performing weighting according to a light emitting current rate of each color at the time of displaying a gray scale with respect to a picture signal of each of the colors R, G, and B. Being averaged by an averaging means 23, each signal weighted by this weighting means 22A acquires an APL value. The peak brightness control means 29 is controlled using this APL value so that PLE operation of controlling a peak brightness of the picture signal is realized. Further, a lighting rate calculation means for calculating the lighting rate of the pixel, in the display panel, which is lit and driven based on image data, and a brightness control means for controlling emission brightness of each of said pixels according to the lighting rate obtained by said lighting rate calculation means are provided.

This application is a division of application Ser. No. 11/546,533 filed Oct. 12, 2006, which is hereby incorporated by reference in its entirety.

### BACKGROUND OF THE INVENTION

1. Field of the Invention

The present invention relates to a drive apparatus for a display panel in which a large number of light emitting elements as pixels are arranged, for example, in a matrix pattern, and in particular to a drive apparatus and a drive method for a light-emitting display panel for controlling display brightness according to a lighting rate of the above-mentioned pixel.

2. Description of the Related Art

For example, in PDP (plasma display panel) etc., finding an average brightness level (or APL=Average Picture Level) of a picture signal to be displayed, a PLE (Peak Luminance Enhancement) control means is employed which controls the display brightness of the above-mentioned picture signal based on this average picture level.

As for the above-mentioned PLE control means, in the case where the average picture level is small (or when the whole picture is dark) with respect to signal having even the same brightness level, a peak brightness level is set to be high so that high brightness display may be provided. On the other hand, in the case where the average picture level is high (when the whole picture is bright), the peak brightness level is lowered so as to inhibit power consumption. By carrying out PLE control in this way, it is possible to realize low power consumption and also possible to display an image of good contrast.

As described above, the display apparatus provided with the PLE control means which finds the average picture level APL of the picture signal to be displayed and controls the display brightness by this APL is disclosed in patent documents 1 and 2 as listed below, for example.

[Patent document 1] Japanese Patent Publication (KOKAI) No. H9-281927

[Patent document 2] Japanese Patent Publication (KOKAI) No. 2001-175220

Incidentally, when performing the above-mentioned PLE control, and when picture signals are R (red), G (green), and B (blue) signals, the picture signal is converted into gray scale (brightness) data to find the above-mentioned APL value. In this case, even if the values of R, G, and B signals are the same value, when a color picture signal is converted into gray scale, the resultant brightnesses (apparent whiteness) on the gray scale are different from one another. For example, in NTSC, an emission brightness ratio (R:G:B) (for respective colors) is about 3:6:1.

Therefore, when converting the color picture signal into a gray scale signal, weighting is conventionally carried out according to an emission brightness rate (proportion) of each color at the time of displaying the gray scale, and a means for calculating the above-mentioned APL is employed.

FIG. 1 is for explaining a basic structure of a conventional APL calculation means in the case of treating the color picture signal. A block indicated by reference numeral 31 shows a brightness rate weighting means for receiving each of picture signals R, G, and B and weighting it according to the brightness rate of each color. A block indicated by reference numeral 32 shows an averaging means for calculating an average value by summing each of the weighted picture signals.

The above-mentioned brightness rate weighting means 31 and the averaging means 32 constitute an APL calculation means 33, and a peak brightness control means 34 is controlled by APL output from this APL calculation means 33. The above-mentioned PLE control is realized such that peak brightness of a composite picture signal is controlled by the above-mentioned APL output in the above-mentioned peak brightness control means 34. In other words, the above-mentioned APL calculation means 33 and the above-mentioned peak brightness control means 34 constitute a PLE control means 35.

In the above-mentioned brightness rate weighting means 31, in order to simplify the explanation of its operation, it is assumed that a brightness ratio (luminance proportions) of the pixels of the respective colors required to obtain the achromatic color (white color) is R:G:B=3:6:1, for example. In this case, the picture signal of R, the picture signal of G, and the picture signal of B are respectively multiplied and weighted by 3/(3+6+1), 6/(3+6+1), and 1/(3+6+1).

The picture signals respectively weighted in the above-mentioned brightness rate weighting means 31 are added together to calculate an average value by the above-mentioned averaging means 32. This average value is outputted from the APL calculation means 33 as APL (average picture level), and is supplied as a control signal to the above-mentioned peak brightness control means 34. In other words, the above-mentioned APL is calculated by the following Equation 1.

APL=R×3/(3+6+1)+G×6/(3+6+1)+B×1/(3+6+1) (Equation 1)

Incidentally, in these days, a display panel has been realized which can be thinned and provide display of a high quality and uses an organic EL (electroluminescence) element taking advantage of a characteristic of being a self-emitting type element. There is also part of the background that a light-emitting functional layer of the element employs an organic compound which can expect a good light-emission property, so that the organic EL display panel has as high an efficiency and long a lifetime as can be put into practical use.

The above-mentioned organic EL element can be electrically represented in an equivalent circuit as shown in FIG. 2. In other words, the organic EL element can be represented by a structure including a diode component E as a light emitting element and a parasitic capacitance component Cp combined in parallel with the diode component E, and it can be said that the organic EL element is a capacitive light-emitting element.

As for this organic EL element, when a light-emitting drive voltage is applied, charge which is equivalent to capacitance of the element first flows into an electrode as displacement current and is accumulated. Then, if a fixed voltage (light-emitting threshold voltage=Vth) inherent to the element is exceeded, electric current begins to flow from one electrode (anode side of the diode component E) into an organic layer which constitutes a light-emitting layer. Thus, the EL element may be considered to emit light at an intensity proportional to the electric current.

FIG. 3 show light-emission static characteristics of such an organic EL element. According to this, the organic EL element emits light at a brightness L substantially proportional to drive electric current I as shown in FIG. 3A As shown by a solid line in FIG. 3B, when a drive voltage V is equal to or greater than the light-emitting threshold voltage Vth, the electric current I flows rapidly so that light is emitted.

In other words, when the drive voltage is not greater than the light-emitting threshold voltage Vth, electric current little flows into EL element, and does not emit light. Therefore, as shown by a solid line in FIG. 3B brightness properties of the EL element are such that the higher the voltage V to be applied is, the greater the emission brightness L becomes in a light emittable region where the drive voltage is greater than the above-mentioned threshold voltage Vth.

Furthermore, it is also known that the brightness properties of the organic EL element generally change with temperature as shown by a dashed line in FIG. 3B. In other words, in the light emittable region where the drive voltage is greater than the above-mentioned light-emitting threshold voltage, the EL element has the property that the greater the value of the voltage V applied to it is, the greater the emission brightness L is, while the higher the ambient temperature is, the smaller the light-emitting threshold voltage becomes. Therefore, EL element is in a situation where light can be emitted with a smaller applied voltage at a higher the temperature, and has a temperature dependent brightness where it is bright at a high temperature and dark at a low temperature even if the same voltage capable of emitting light is applied.

Furthermore, the above-mentioned EL element has a problem that luminous efficiencies with respect to the drive voltages differ according to the luminescence colors. The luminous efficiencies of EL elements, which may currently be put into practical use, emitting respectively the above-mentioned R, G, and B are in a situation where the luminous efficiency of G is generally higher and the luminous efficiencies of R and B are lower as shown in FIG. 3C. Further, each of the EL elements emitting R, G, and B has temperature dependency as shown in FIG. 3B.

As described above, when trying to realize the above-mentioned PLE control in the display apparatus for a color display panel in which a color display pixel is constituted by a light emitting element, as a sub-pixel, represented by the organic EL element whose luminous efficiency differs for each color, a technical problem to be described below may arise.

In other words, since the luminous efficiency of the element for each color differs, if brightness is controlled (PLE control) based on the APL value calculated only from the picture signal and the brightness rate as can be seen from a structure shown in FIG. 1, operation to raise peak brightness is performed by way of PLE control. For example, when a light emitting element with a low luminous efficiency and a low brightness rate provides a high lighting rate (equivalent to the above-mentioned APL value), it is determined that “a dark screen” is displayed despite the high lighting rate.

For example, assuming that the brightness ratio is R:G:B=3:6:1 as described above, the luminous efficiency of a blue (B) light emitting element is the lowest and that only the above-mentioned blue light emitting element is fully lit, the APL output at this time is APL=B×1/(3+6+1) according to the above-mentioned Equation 1, and is determined to be “a very dark screen”. Therefore, a problem arises in that although blue has the lowest luminous efficiency, it is controlled so that the peak brightness is to rise, thus increasing power consumption and damaging the effect of the above-mentioned PLE which lowers the peak brightness at the time of the rate of high lighting, and inhibits the power consumption.

Further, as described above, since the emission brightness has characteristics depending on a current value in the display panel using the EL element as a display pixel, power consumption considerably varies depending on the lighting rate of the pixel according to the picture signal to be displayed. In other words, as shown in FIG. 4, luminescence consumption current applied to the display panel is substantially proportional to the lighting rate of the pixels in the display panel (the number of light-emitting pixels).

Therefore, there is a problem in that a power supply circuit for supplying drive current to the above-mentioned display panel needs to secure output capacity which is sufficient for supplying predetermined drive current to each pixel, when the lighting rate of the above-mentioned pixel is the maximum (100%), and that a size of each component used for the power supply circuit and the whole size are inevitably increased.

In addition, a PLE controlling method which inhibits an amount of current supplied to the display panel by controlling the lighting rate according to display image data is disclosed in patent document 3 listed below.

[Patent document 3] Japanese Patent Publication (KOKAI) 2005-189636

### SUMMARY OF THE INVENTION

The present invention is made in view of the above-mentioned technical problems, and a first object is to provide a drive apparatus and a drive method for a light-emitting display panel in a drive apparatus for a color display panel constituted by the light emitting elements whose luminous efficiencies for respective colors differ from one another, which can prevent an unsuitable APL value (lighting rate) in view of the field of power consumption from being calculated due to a difference in luminous efficiency.

Further, basically following the above-mentioned PLE controlling method, a second object of the present invention is to provide a drive apparatus and a drive method of for light-emitting display panel, which can solve a problem that the size of the component in a power supply unit is increased, as described above.

In order to attain the above-mentioned first object, a first preferred fundamental aspect in the light-emitting display panel in accordance with the present invention is a light-emitting display panel in which light emitting elements of a plurality of colors are arranged in a matrix pattern and each of the above-mentioned light emitting elements is selectively caused and driven to emit light based on a picture signal, the light-emitting display panel including an APL calculation means for calculating an average picture level (APL) from the above-mentioned picture signal, and a peak brightness control means for variably controlling peak brightness in the above-mentioned picture signal according to APL calculated by the above-mentioned APL calculation means, wherein the above-mentioned APL calculation means is provided with a weighting means for weighting a picture signal of each color according to a light emitting current rate of each color at the time of displaying a gray scale.

Further, a second preferred fundamental aspect in the light-emitting display panel in accordance with the present invention in order to attain the above-mentioned first object is a light-emitting display panel in which light emitting elements of a plurality of colors are arranged in a matrix pattern and each of the above-mentioned light emitting elements is selectively caused and driven to emit light based on a picture signal, the light-emitting display panel including an APL calculation means for calculating an average picture level (APL) from the above-mentioned picture signal, and a peak brightness control means for variably controlling peak brightness in the above-mentioned picture signal according to APL calculated by the above-mentioned APL calculation means, wherein the above-mentioned APL calculation means is provided with a weighting means for weighting a picture signal of each color according to a light emitting power rate of each color at the time of displaying a gray scale.

On the other hand, in order to attain the above-mentioned first object, a first preferred fundamental aspect in the drive method for the light-emitting display panel in accordance with the present invention is a drive method for a light-emitting display panel in which light emitting elements of a plurality of colors are arranged in a matrix pattern and each of the above-mentioned light emitting elements is selectively caused and driven to emit light based on a picture signal, wherein an average picture level (APL) is calculated from the above-mentioned picture signal by an APL calculation means and APL information data calculated by the above-mentioned APL calculation means are supplied as a control signal to a peak brightness control means, so as to perform variable control operation for peak brightness for variably controlling the peak brightness in the above-mentioned picture signal; when calculating the above-mentioned average picture level, the above-mentioned APL calculation means performs weighting operation for weighting a picture signal of each color according to a light emitting current rate of each color at the time of displaying a gray scale.

Further, in order to attain the above-mentioned first object, a second preferred fundamental aspect in the drive method for the light-emitting display panel in accordance with the present invention is a drive method for a light-emitting display panel in which light emitting elements of a plurality of colors are arranged in a matrix pattern and each of the above-mentioned light emitting elements is selectively caused and driven to emit light based on a picture signal, wherein an average picture level (APL) is calculated from the above-mentioned picture signal by an APL calculation means and APL information data calculated by the above-mentioned APL calculation means are supplied as a control signal to a peak brightness control means, so as to perform variable control operation for peak brightness for variably controlling the peak brightness in the above-mentioned picture signal; when calculating the above-mentioned average picture level, the above-mentioned APL calculation means performs weighting operation for weighting a picture signal of each color according to a light emitting power rate of each color at the time of displaying a gray scale.

Furthermore, in order to attain the above-mentioned first object, a third preferred fundamental aspect in the drive method for the light-emitting display panel in accordance with the present invention is a drive method for a light-emitting display panel in which light emitting elements of a plurality of colors are arranged in a matrix pattern and each of the above-mentioned light emitting elements is selectively caused and driven to emit light based on a picture signal, wherein an average picture level (APL) is calculated from the above-mentioned picture signal by an APL calculation means and APL information data calculated by the above-mentioned APL calculation means are supplied as a control signal to a peak brightness control means, so as to perform variable control operation for peak brightness for variably controlling the peak brightness in the above-mentioned picture signal; when calculating the above-mentioned average picture level, the above-mentioned APL calculation means selectively performs either first weighting operation for weighting a picture signal of each color according to a light emitting current rate of each color at the time of displaying a gray scale, or second weighting operation for weighting the picture signal of each color according to an emission brightness rate of each color at the time of displaying the gray scale.

Still further, in order to attain the above-mentioned first object, a fourth preferred fundamental aspect in the drive method for the light-emitting display panel in accordance with the present invention is a drive method for a light-emitting display panel in which light emitting elements of a plurality of colors are arranged in a matrix pattern and each of the above-mentioned light emitting elements is selectively caused and driven to emit light based on a picture signal, wherein an average picture level (APL) is calculated from the above-mentioned picture signal by an APL calculation means and APL information data calculated by the above-mentioned APL calculation means are supplied as a control signal to a peak brightness control means, so as to perform variable control operation for peak brightness for variably controlling the peak brightness in the above-mentioned picture signal; when calculating the above-mentioned average picture level, the above-mentioned APL calculation means selectively performs either first weighting operation for weighting a picture signal of each color according to a light emitting power rate of each color at the time of displaying a gray scale, or second weighting operation for weighting the picture signal of each color according to an emission brightness rate of each color at the time of displaying the gray scale.

Further, in order to attain the above-mentioned first object, a fifth preferred fundamental aspect in the drive method for the light-emitting display panel in accordance with the present invention is a drive method for a light-emitting display panel in which light emitting elements of a plurality of colors are arranged in a matrix pattern and each of the above-mentioned light emitting elements is selectively caused and driven to emit light based on a picture signal, wherein an average picture level (APL) is calculated from the above-mentioned picture signal by an APL calculation means and APL information data calculated by the above-mentioned APL calculation means are supplied as a control signal to a peak brightness control means, so as to perform variable control operation for peak brightness for variably controlling the peak brightness in the above-mentioned picture signal; when calculating the above-mentioned average picture level, the above-mentioned APL calculation means performs first weighting operation for weighting a picture signal of each color according to a light emitting current rate of each color at the time of displaying a gray scale and second weighting operation for weighting the picture signal of each color according to an emission brightness rate of each color at the time of displaying the gray scale.

Further, in order to attain the above-mentioned first object, a sixth preferred fundamental aspect in the drive method for the light-emitting display panel in accordance with the present invention is a drive method for a light-emitting display panel in which light emitting elements of a plurality of colors are arranged in a matrix pattern and each of the above-mentioned light emitting elements is selectively caused and driven to emit light based on a picture signal, wherein an average picture level (APL) is calculated from the above-mentioned picture signal by an APL calculation means and APL information data calculated by the above-mentioned APL calculation means are supplied as a control signal to a peak brightness control means, so as to perform variable control operation for peak brightness for variably controlling the peak brightness in the above-mentioned picture signal; when calculating the above-mentioned average picture level, the above-mentioned APL calculation means performs first weighting operation for weighting a picture signal of each color according to a light emitting power rate of each color at the time of displaying a gray scale and second weighting operation for weighting the picture signal of each color according to an emission brightness rate of each color at the time of displaying the gray scale.

Further, in order to attain the above-mentioned second object, a first preferred fundamental aspect in the light-emitting display panel in accordance with the present invention is a light-emitting display panel in which pixels each having a light emitting element are arranged at intersections where a plurality of data lines intersect with a plurality of scanning lines, and one frame (period) is divided into a plurality of sub-frames to realize gradation control by selecting the above-mentioned sub-frames (periods) and by summing the lighting periods of the pixel within one frame period, the above-mentioned light-emitting display panel including a lighting rate calculation means for calculating a lighting rate of the pixel in the above-mentioned display panel to be lit and driven based on image data, and a brightness control means for controlling emission brightness of each of the above-mentioned pixels according to the lighting rate obtained by the above-mentioned lighting rate calculation means, wherein emission brightness of each of the above-mentioned pixels is controlled by controlling proportions of the lighting period and a non-lighting period of the pixel in one frame period based on the above-mentioned lighting rate.

Further, in order to attain the above-mentioned second object, a second preferred fundamental aspect in the light-emitting display panel in accordance with the present invention is a light-emitting display panel in which pixels each having a light emitting element are arranged at intersections where a plurality of data lines intersect with a plurality of scanning lines, the above-mentioned light-emitting display panel including a scanning driver for selectively setting each of the above-mentioned scanning lines as a scanning selection potential or a non-scanning selection potential, and a data driver for selectively connecting each of the above-mentioned data lines to a lighting driving power supply or a non-lighting driving power supply, the above-mentioned light-emitting display panel including a lighting rate calculation means for calculating a lighting rate of the pixel in the above-mentioned display panel to be lit and driven based on image data, and a brightness control means for controlling emission brightness of each of the above-mentioned pixels according to the lighting rate obtained by the above-mentioned lighting rate calculation means, wherein emission brightness of each of the above-mentioned pixels is controlled by controlling a period when the above-mentioned lighting driving power supply is connected with the above-mentioned data line based on the above-mentioned lighting rate.

Further, in order to attain the above-mentioned second object, a third preferred fundamental aspect in the light-emitting display panel in accordance with the present invention is a light-emitting display panel in which pixels each having a light emitting element are arranged at intersections where a plurality of data lines intersect with a plurality of scanning lines, and an image is displayed by selectively lighting and driving the above-mentioned pixels, the above-mentioned light-emitting display panel including a lighting rate calculation means for calculating a lighting rate of the pixel in the above-mentioned display panel to be lit and driven based on image data, and a brightness control means for controlling emission brightness of each of the above-mentioned pixels according to the lighting rate obtained by the above-mentioned lighting rate calculation means, wherein the above-mentioned brightness control means controls emission brightness of each of the above-mentioned pixels by controlling an output value of a drive power supply to be provided for each of the above-mentioned pixels based on the above-mentioned lighting rate.

Further, in order to attain the above-mentioned second object, a fourth preferred fundamental aspect in the light-emitting display panel in accordance with the present invention is a light-emitting display panel in which pixels each having a light emitting element are arranged at intersections where a plurality of data lines intersect with a plurality of scanning lines, and an image is displayed by selectively lighting and driving the above-mentioned pixels, the above-mentioned light-emitting display panel including a lighting rate calculation means for calculating a lighting rate of the pixel in the above-mentioned display panel to be lit and driven based on image data, and a brightness control means for controlling emission brightness of each of the above-mentioned pixels according to the lighting rate obtained by the above-mentioned lighting rate calculation means, wherein the above-mentioned brightness control means is arranged to control the emission brightness of each of the above-mentioned pixels by performing a conversion process for the above-mentioned image data based on said lighting rate.

Now, in order to attain the second object of the above, a first preferred fundamental aspect in the drive method of the light-emitting display panel in accordance with the present invention is a drive method for a light-emitting display panel in which pixels each having a light emitting element are arranged in intersections where a plurality of data lines intersect with a plurality of scanning lines, and one frame (period) is divided into a plurality of sub-frames to realize gradation control by selecting the above-mentioned sub-frames (periods) and by summing the lighting periods of the pixel within one frame period, wherein emission brightness of each of the above-mentioned pixels is controlled by calculating a lighting rate of the pixel in the above-mentioned display panel to be lit and driven based on image data, and by controlling proportions of the lighting period and a non-lighting period of the pixel in one frame period based on the above-mentioned calculated lighting rate.

Further, in order to attain the above-mentioned second object, a second preferred fundamental aspect in the drive method for the light-emitting display panel in accordance with the present invention is a drive method for a light-emitting display panel in which pixels each having a light emitting element are arranged at intersections where a plurality of data lines intersect with a plurality of scanning lines, the above-mentioned display panel including a scanning driver for selectively setting each of the above-mentioned scanning lines as a scanning selection potential or a non-scanning selection potential, and a data driver for connecting each of the above-mentioned data lines to a lighting driving power supply or a non-lighting driving power supply, wherein a lighting rate of the pixel in the above-mentioned display panel to be lit and driven is calculated based on image data, and emission brightness of each of the above-mentioned pixels is controlled by controlling a period when the above-mentioned lighting driving power supply is connected with the above-mentioned data line based on the above-mentioned calculated lighting rate.

Further, in order to attain the above-mentioned second object, a third preferred fundamental aspect in the drive method for the light-emitting display panel in accordance with the present invention is a drive method for a light-emitting display panel in which pixels each having a light emitting element are arranged at intersections where a plurality of data lines intersect with a plurality of scanning lines, and an image is displayed by selectively lighting and driving the above-mentioned pixels, wherein a lighting rate of the pixel in the above-mentioned display panel to be lit and driven is calculated based on image data, and emission brightness of each of the above-mentioned pixels is controlled by controlling an output value of a drive power supply to be provided for each of the above-mentioned pixels based on the above-mentioned calculated lighting rate.

Further, in order to attain the above-mentioned second object, a fourth preferred fundamental aspect in the drive method for the light-emitting display panel in accordance with the present invention is a drive method for a light-emitting display panel in which pixels each having a light emitting element are arranged at intersections where a plurality of data lines intersect with a plurality of scanning lines, and an image is displayed by selectively lighting and driving the above-mentioned pixels, wherein a lighting rate of the pixel in the above-mentioned display panel to be lit and driven is calculated based on image data, and emission brightness of each of the above-mentioned pixels is controlled by performing a conversion process for the above-mentioned image data based on the above-mentioned calculated lighting rate.

### BRIEF DESCRIPTION OF THE DRAWINGS

FIG. 1 is a block diagram for explaining a basic structure of a conventional APL calculation means in the case of treating a color picture signal.

FIG. 2 is an equivalent circuit diagram of an organic EL element.

FIGS. 3A-3C are graphs showing static characteristics of the organic EL element.

FIG. 4 is a characteristic graph showing a relationship between a lighting rate of a pixel and luminescence consumption current by means of a conventional drive apparatus.

FIG. 5 is a block diagram showing the whole structure of a drive apparatus including a display panel.

FIG. 6 is a circuit diagram showing an example of a structure of a pixel arranged at the light-emitting display panel as shown in FIG. 5.

FIG. 7 is a block diagram for explaining first and second preferred embodiments which is suitably applicable to a PLE control unit as shown in FIG. 5.

FIG. 8 is a block diagram for explaining a third preferred embodiment similarly applicable to the PLE control unit.

FIG. 9 is a block diagram for explaining a fourth preferred embodiment similarly applicable to the PLE control unit.

FIG. 10 is a block diagram showing a fifth preferred embodiment in a drive apparatus for a display panel in accordance with the present invention.

FIG. 11 is a circuit diagram showing an example of a structure of the pixel arranged at the display panel as shown in FIG. 10.

FIG. 12 is a timing chart for explaining operation in the drive apparatus as shown in FIG. 10.

FIG. 13 is a block diagram for explaining basic function of dimmer setup used in the structure as shown in FIG. 10.

FIG. 14 is a block diagram showing a sixth preferred embodiment in the drive apparatus of the display panel in accordance with the present invention.

FIG. 15 is a timing chart for explaining operation of the drive apparatus as shown in FIG. 14.

FIG. 16 is a block diagram showing a seventh preferred embodiment in the drive apparatus of the display panel in accordance with the present invention.

FIG. 17 is a circuit diagram showing an example of a structure of the pixel arranged at the display panel as shown in FIG. 16.

FIG. 18 is a circuit diagram showing an example of a DC-DC converter used in the drive apparatus as shown in FIG. 16.

FIG. 19 is a block diagram showing an eighth preferred embodiment in the drive apparatus of the display panel in accordance with the present invention.

FIG. 20 is a circuit diagram showing a specific example of a data driver used in the structure as shown in FIG. 19.

FIG. 21 is a block diagram showing a ninth preferred embodiment in the drive apparatus of the display panel in accordance with the present invention.

FIG. 22 is a circuit diagram showing an example of a structure of the pixel arranged at the display panel as shown in FIG. 21.

FIG. 23 is a timing chart for explaining a gradation control means employed in the structure as shown in FIG. 21.

FIG. 24 is a block diagram showing a tenth preferred embodiment in the drive apparatus of the display panel in accordance with the present invention.

### DESCRIPTION OF THE PREFERRED EMBODIMENTS

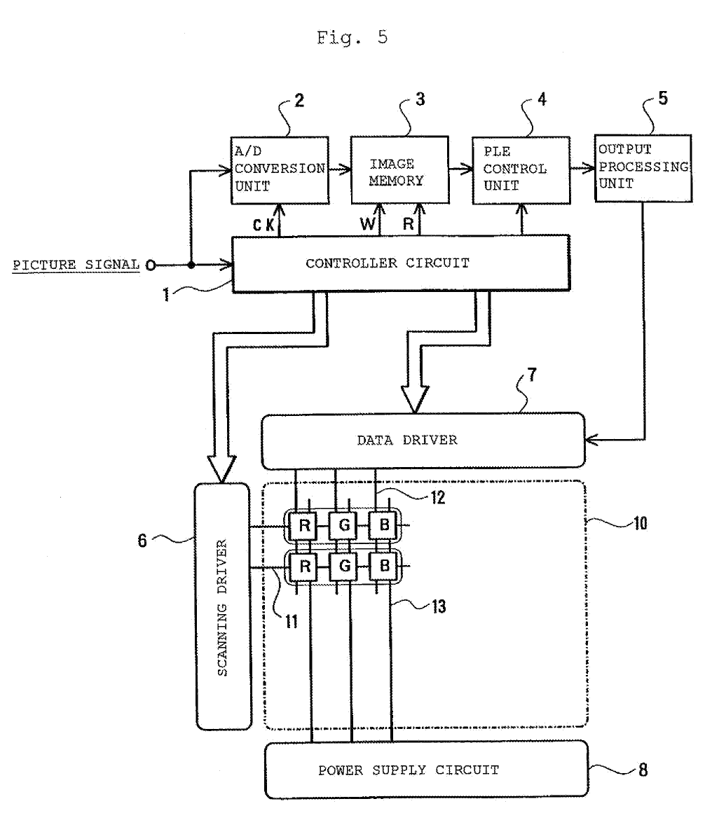

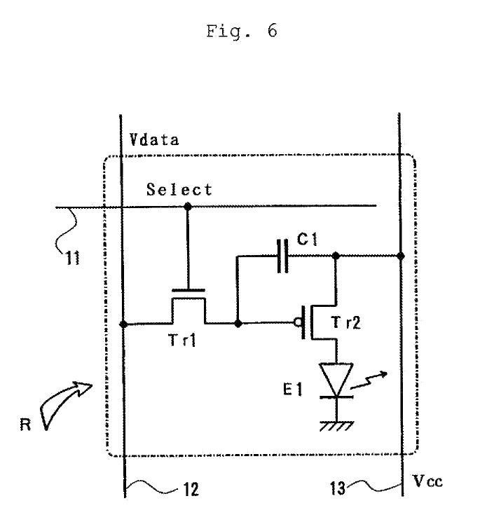

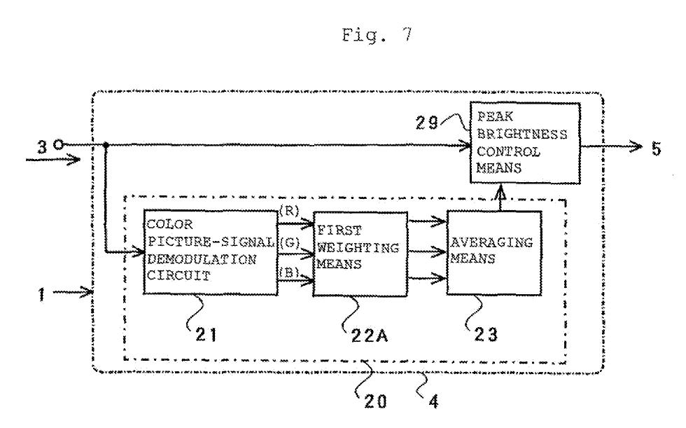

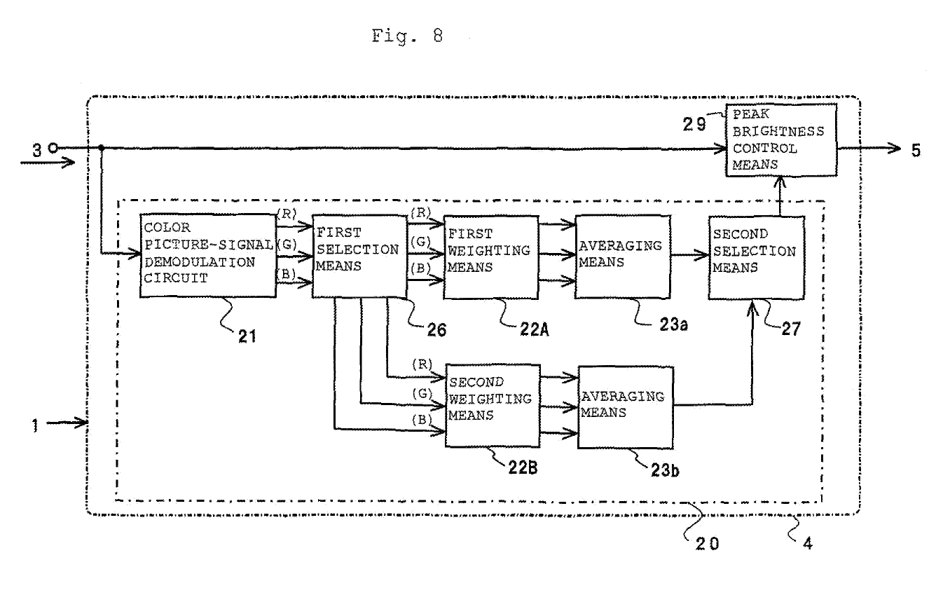

Hereafter, a drive apparatus for a light-emitting display panel in accordance with the present invention will be described with reference to preferred embodiments shown in the drawings. FIG. 5 shows the whole structure of the drive apparatus including the light-emitting display panel by means of a block diagram, and is applied to a first through fourth preferred embodiments of the present invention. Further, this constitutes a drive apparatus for an active-matrix type display panel.

In the drive apparatus, a controller circuit 1 which generates various types of timing signals is connected with an analog/digital (A/D) conversion unit 2, an image memory 3 capable of storing a picture signal for at least one frame, and a PLE control unit 4 as a peak brightness control means capable of controlling display brightness of the picture signal. In a preferred embodiment as shown in this FIG. 5, an analog picture signal is arranged to be supplied to the controller circuit 1 and the A/D conversion unit 2. Based on horizontal and vertical synchronizing signals in the analog picture signal, the above-mentioned controller circuit 1 generates a clock signal CK for the above-mentioned A/D conversion unit 2, and a write-in signal W and a read-out signal R for the above-mentioned image memory 3.

Based on the clock signal supplied from the controller circuit 1, the above-mentioned A/D conversion unit 2 samples an inputted analog signal and operates to convert this into a picture signal for each pixel to be supplied to the image memory 3. The above-mentioned image memory 3 operates so that the picture signal for every pixel supplied from the A/D conversion unit 2 may be written in the image memory 3 one by one according to the write-in signal W from the above-mentioned controller circuit 1.

As described above, a frame memory is used as the above-mentioned image memory 3, and data for one screen in the display panel is written in by way of the above-mentioned write-in operation, as will be described later. Further, the picture signal written in the image memory 3 is read according to the read-out signal R outputted from the above-mentioned controller circuit 1, and is arranged to be supplied to the above-mentioned PLE control unit 4.

As for the picture signal read from the above-mentioned image memory 3, this PLE control unit 4 operates so that the display brightness may be controlled for each frame period, for example. For this reason, it is arranged that a synchronization signal in synchronism with one frame period is supplied from the controller circuit 1 to the PLE control unit 4. In addition, a more particular structure of the above-mentioned PLE control unit 4 and its operation will be described in detail later. The picture signal outputted from the above-mentioned PLE control unit 4 is supplied to an output processing unit 5, and this output processing unit 5 converts the above-mentioned picture signal into a signal form to be outputted which can be driven in a data driver 7 as will be described later.

In addition, based on the above-mentioned horizontal and vertical synchronizing signals in the picture signal, the above-mentioned controller circuit 1 is arranged to generate a shift clock signal, a start pulse, etc. for a scanning driver 6 and a data driver 7 to supply them to each of the drivers 6 and 7.

Reference numeral 10 shown in FIG. 5 indicates a display panel in which a large number of display pixels (each containing a light emitting element) arranged in a matrix pattern. In this display panel 10, color display pixels having a group of sub-pixels including EL elements which respectively emit light in red, green, and blue as shown by R, G, and B are arranged horizontally and vertically in a matrix pattern.

Further, a scanning line 11 and a data line 12 which are respectively connected to the above-mentioned scanning driver 6 and the data driver 7 are arranged perpendicularly to each other at the above-mentioned display panel 10. In the intersections, the sub-pixels R, G, and B including the above-mentioned EL elements are arranged at it, respectively.

In addition, it is arranged that a voltage for lighting and driving the pixel is supplied from the power supply circuit 8 through a power supply line 13 to each of the above-mentioned sub-pixels.

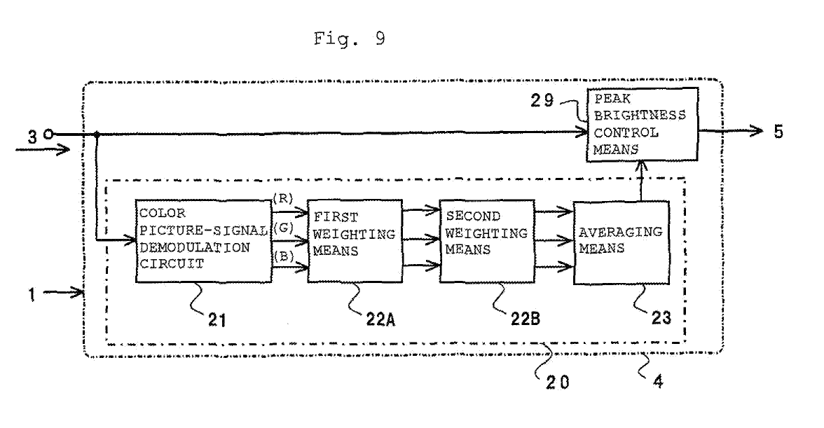

FIG. 6 shows a circuit structure corresponding to one sub-pixel R arranged at the above-mentioned display panel 10, and this shows the most fundamental pixel structure in the case of using the EL element as a light emitting element. In addition, although the circuit structure of the pixel corresponding to R is typically shown as a sub-pixel in FIG. 6, the circuit structure of this pixel is applied identically to other sub-pixels of G and B.

This pixel R is arranged so that a data signal Vdata corresponding to the picture signal from the above-mentioned data driver 7 may be supplied to a source of TFT for control, i.e., a data write-in transistor Tr1, through the data line 12 arranged at the display panel.

It is arranged that a scanning signal Select (hereafter also referred to as a write-in pulse) may be supplied to a gate of the above-mentioned data write-in transistor Tr1 through the scanning line 11 connected to a scanning driver 6. A drain of the above-mentioned data write-in transistor Tr1 is connected to a gate of a lighting and driving TFT i.e., a lighting and driving transistor Tr2 and also connected to one terminal of a capacitor C1 for holding electric charges.

Further, a source of the lighting and driving transistor Tr2 is arranged to be connected with the other terminal of the above-mentioned capacitor C1 and supplied with a drive voltage Vcc from the above-mentioned power supply circuit 8 via a power supply line 13. A drain of the above-mentioned lighting and driving transistor Tr2 is connected to an anode terminal of an organic EL element E1 as a light emitting element, and a cathode terminal of this organic EL element E1 is connected to a reference potential point (ground) of the display panel 10.

In addition, in the circuit structure of the pixel R as shown in FIG. 6, the data write-in transistor Tr1 is constituted by an n-channel type TFT, and the drive transistor Tr2 is constituted by a p-channel type TFT. The thus arranged pixel forms a color display pixel by combining the sub-pixels of R, G, and B into a group. As shown in FIG. 5, a large number of the color display pixels are arranged in a matrix pattern in row and column directions so as to constitute the display panel 10.

In the structure of the pixel R as shown in FIG. 6, the write-in pulse Select as a scanning signal is supplied to the gate of the control transistor Tr1 from the scanning driver 6 in an address period. At this time, when the data signal Vdata supplied from the data driver 7 is a datum for causing the pixel to turn on, current corresponding to the data signal Vdata flows into the capacitor C1 through the source and drain of the control transistor Tr1, and the capacitor C1 is charged.

Then, the charge voltage is supplied to a gate of the drive transistor Tr2, the transistor Tr2 causes current corresponding to its gate voltage and the drive voltage Vcc supplied to the source to flow into the above-mentioned EL element E1, whereby the EL element E1 emits light.

If application of the above-mentioned write-in pulse to the gate of the above-mentioned control transistor Tr1 is stopped, the transistor Tr1 is so-called cut off. However, the gate voltage of the drive transistor Tr2 is held by the electric charge accumulated in the capacitor C1, whereby the drive current to the EL element E1 is maintained.

In this embodiment, light emission of each pixel arranged at the display panel 10 is controlled based on the picture signal in which brightness is controlled in the above-mentioned PLE control unit 4. In this case, as one means, based on the picture signal in which the brightness control is carried out in the above-mentioned PLE control unit 4, the brightness (gradation) of each sub-pixel can be controlled by controlling a voltage value of the data signal Vdata supplied from the data driver 7 through each data line 12 to the source of the transistor Tr1 for control, for example, whereby control of the peak brightness of the pixel can be realized by the above-mentioned PLE. In addition, at this time, a display color in one color display pixel can be adjusted by controlling the gradation among the above-mentioned R, G and B separately.

Further, as another means, one frame (period) is divided into a plurality of sub-frames and the pixel is controlled to be lighting or non-lighting on a sub-frame by sub-frame basis, so that the brightness (gradation) control of each pixel can be realized by summing the lighting periods of the pixel in one frame period. Also by using such a sub-frame method, it is possible to realize control of the peak brightness of the pixel based on the above-mentioned PLE control. Also in this case, by carrying out gradation control of the sub-pixel of each of the above-mentioned R, G, and B separately on a sub-frame by sub-frame basis, the display color in one color display pixel can be adjusted.

By means of a block diagram, FIG. 7 shows a first preferred embodiment which can be suitably applied to the PLE control unit 4 as shown in FIG. 5. In the structure as shown in this FIG. 7, the picture signal read from the image memory 3 is supplied to a color signal demodulation circuit 21 which constitutes the APL calculation means 20 to be demodulated to picture signals corresponding to the above-mentioned R, G, and B. In other words, it is arranged here that they are outputted as the picture signals having a level respectively corresponding to the brightnesses of R, G, and B.

The respective picture signals corresponding to R, G, and B outputted from the above-mentioned circuit 21 are supplied to a weighting means 22A, and each of the picture signals R, G, and B is weighted. In this weighting means 22A, in order to obtain the same brightness with respect to each color of the picture signals R, G, and B, weighting is carried out according to the light emitting current rates (proportions) required for the respective light emitting elements of the respective colors, i.e., the light emitting current rates of the respective colors at the time of displaying gray scales. In addition, this weighting means 22A is referred to as a first weighting means, for convenience.

In order to simplify the explanation of the weighting operation by means of this first weighting means 22A, it is assumed that a light emitting current ratio required for the respective light emitting elements of R, G, and B is R:G:B=1:1:2 to obtain the achromatic color (white color), for example. In this case, the picture signal of R, the picture signal of G, and the picture signal of B are respectively multiplied and weighted by 1/(1+1+2), 1/(1+1+2), and 2/(1+1+2).

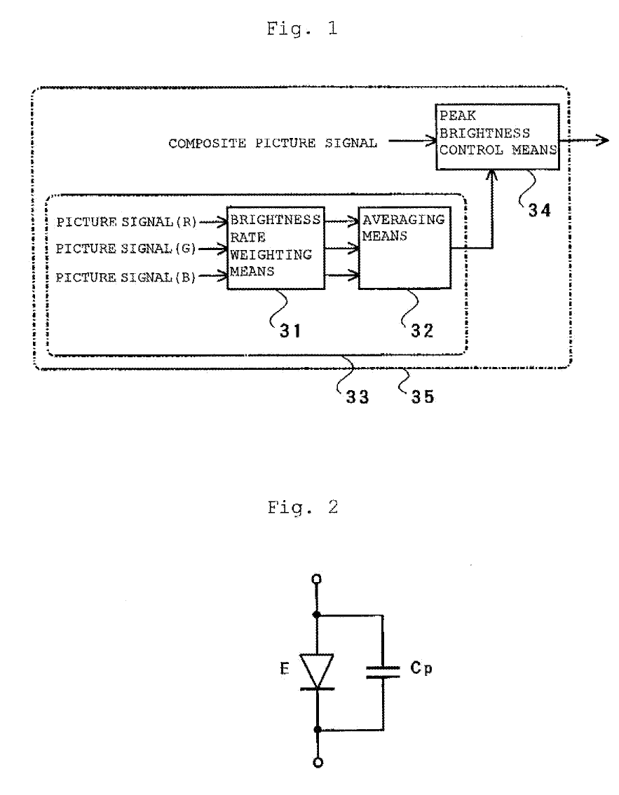

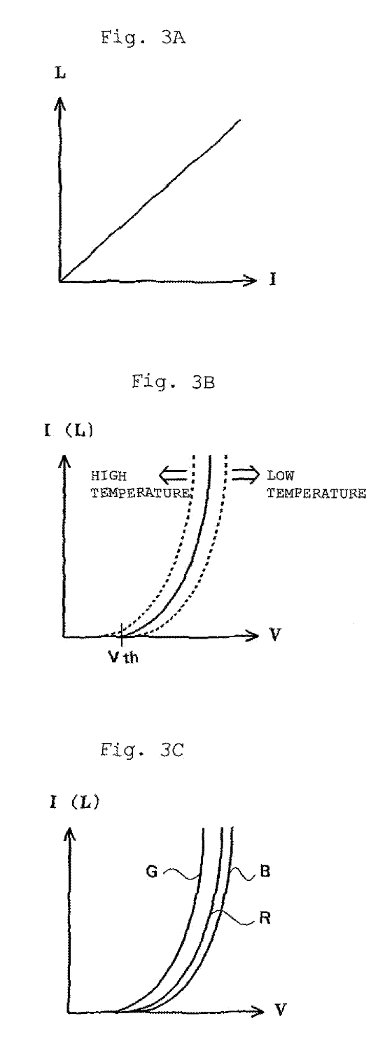

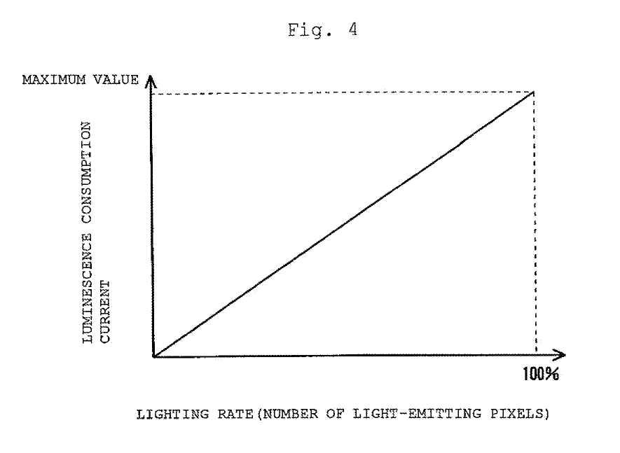

The picture signals weighted by the above-mentioned first weighting means 22A are supplied to the averaging means 23 to calculate an average value, and this average value is outputted from the APL calculation means 20 as APL (average picture level). The operation of calculating the average value in the above-mentioned averaging means 23 is as already described with reference to the structure shown in FIG. 1, and the APL output at this time is found by the following Equation 2.

APL=R×1/(1+1+2)+G×1/(1+1+2)+B×2/(1+1+2) (Equation 2)

The APL output found by the above-mentioned APL calculation means 20 is provided as a control signal to a peak brightness control means 29. A composite picture signal read from the above-mentioned image memory 3 is supplied as a signal to be controlled to this peak brightness control means 29. The peak brightness of this picture signal is controlled by the above-mentioned APL output so as to realize the PLE control.

The output by the peak brightness control means 29, i.e., the output by the PLE control unit 4 is supplied to the output processing unit 5, as described above. This output processing unit 5 converts the picture signal into a signal form which can be driven in the data driver 7 and outputs it.

According to the APL calculation output by using the above-mentioned weighting means 22A, in order to obtain the same brightness when display is carried out by the gray scale, weighting is performed according to the rates (proportions) of the light emitting currents needed for the respective light emitting elements of the respective colors. Thus, when the above-mentioned PLE control is introduced into the drive apparatus for the display panel using the light emitting elements represented by an organic EL element whose emission brightness depends on drive current, the APL calculation can be judged suitably. Therefore, regardless of the light emitting elements of R, G, and B, when the lighting rate is high, it is possible to realize the PLE control which lowers the peak brightness and controls power consumption.

Further, in the structure shown in FIG. 7, in order to obtain the same brightness when the display is achieved by the gray scale with respect to the picture signals of R, G, and B of the respective colors, the first weighting means 22A performs the weighting according to rates (proportions) of light emitting power needed for the respective light emitting elements of the respective colors, i.e., light emitting power rates (proportions) of the respective colors at the time of displaying the gray scale. This structure corresponds to the second preferred embodiment which can be suitably applied to the PLE control unit 4 as shown in FIG. 5.

In other words, the weighting means 22A in the first aspect of the already explained PLE control unit 4 “performs the weighting according to the rates (proportions) of the light emitting currents needed for the respective light emitting elements of the respective colors”, while the weighting means 22A in the second aspect “performs the weighting according to the rates (proportions) of the light emitting power needed for the respective light emitting elements of the respective colors”, thus they are different from each other.

However, the light emitting power P of the light emitting element can be represented as P=Vf×If which is a product of a forward direction voltage Vf and current If. In other words, the above-mentioned light emitting power P has a relationship proportional to the forward direction voltage Vf and has a relationship proportional to the above-mentioned light emitting current If. Therefore, the structure which realizes the weighting means 22A in the second aspect of the PLE control unit 4 can be shown as a structure of a block diagram similar to the weighting means 22A in the first aspect as shown in FIG. 7.

The weighting operation by this second means and the above-mentioned PLE operation by means of the APL output generated by the averaging means may provide operational effects similar to those of the weighting operation by the already explained first means and the PLE operation by means of the APL output generated by the averaging means.

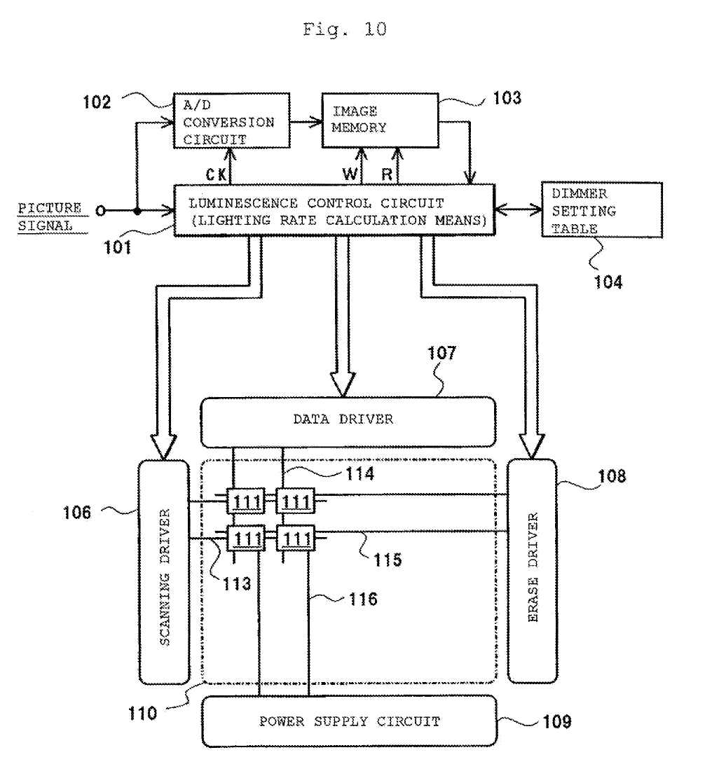

By means of a block diagram, FIG. 8 shows a third preferred embodiment which can be suitably employed for the PLE control unit 4 as shown in FIG. 5. In addition, in FIG. 8, parts performing the same functions as the already described parts in FIG. 7 are given identical reference signs. Accordingly, the description of these will not be repeated.

In the structure as shown in this FIG. 8, a first selection means 26 and a second selection means 27 are added to the already-described structure as shown in FIG. 7. The first selection means 26 is arranged so that the respective picture signals corresponding to R, G, and B from the color signal demodulation circuit 21 can be selectively supplied to first weighting means 22A or the second weighting means 22B. The above-mentioned first weighting means 22A achieves the same function as the first weighting means 22A as shown in FIG. 7.

Further, in order to obtain the same brightness when the display is achieved by the gray scale with respect to the picture signals of R, G, and B of the respective colors, the second weighting means 22B as shown in FIG. 8 performs the weighting according to rates (proportions) of the brightness needed for the respective light emitting elements of the respective colors, i.e. the weighting according to the emission brightness rate (proportion) of each color at the time of displaying the gray scale. This achieves the same function as the already-described brightness rate weighting means as shown in FIG. 1.

Further, the above-mentioned first weighting means 22A and second weighting means 22B are respectively connected with averaging means 23a and 23b. Averaged outputs from these averaging means 23a and 23b are arranged to be supplied to the second selection means 27. The averaged output chosen by the second selection means 27 is arranged to be supplied to the peak brightness control means 29. In other words, the above-mentioned first and second selection means 26 and 27 are arranged so that the averaged outputs from the above-mentioned first and second weighting means 22A and 22B can be chosen alternatively.

According to the structure as shown in FIG. 8, it is possible to choose the above-mentioned weighting by the light emitting current rate (proportion) by means of the first weighting means 22A or the function of the above-mentioned weighting by the brightness rate by means of the conventional second weighting means 22B. In other words, when the above-mentioned weighting operation by the light emitting current rate is chosen by the selection means, it can be set as an energy-saving mode. When the above-mentioned weighting operation by the brightness rate is chosen, it can be set as a high-definition (contrast conscious) mode.

Further, as described in the above-mentioned second preferred embodiment, the first weighting means 22A in the structure as shown in FIG. 8 can also be arranged by replacing with the weighting means for performing the weighting according to the light emitting power rate (proportion) of each color at the time of displaying the gray scale. Thus, in such an arrangement, the above-mentioned energy-saving mode or the contrast conscious mode can be chosen.

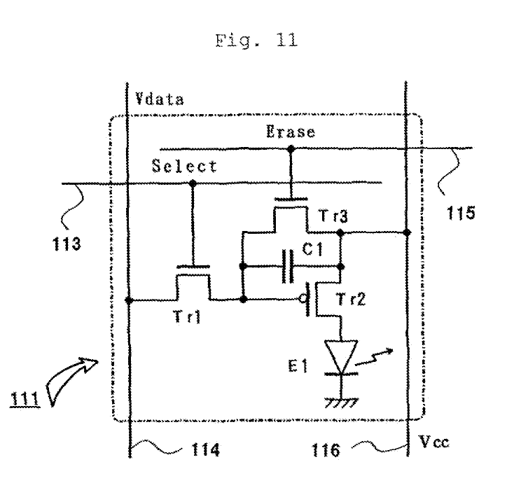

By means of a block diagram, FIG. 9 shows a fourth preferred embodiment which can be suitably employed for the PLE control unit 4 as shown in FIG. 5. In addition, in FIG. 9, parts performing the same functions as the already described parts in FIGS. 7 and 8 are given identical reference signs. Accordingly, the description of these will not be repeated.

In the structure as shown in this FIG. 9, the picture signals of R, G, and B subjected to the above-mentioned weighting operation by the light emitting current rate (proportion) in the first weighting means 22A are further subjected to the above-mentioned weighting operation by the brightness rate in second weighting means 22B. The picture signals of the respective colors subjected to the weighting operations by both means are averaged by the averaging means 23 so as to obtain the APL output. In addition, the same characteristics can be obtained even if the first weighting means 22A is replaced, before or after, with the second weighting means 22B in the structure as shown in FIG. 9.

According to the structure as shown in this FIG. 9, it is possible to obtain the characteristics provided with the already explained characteristics of the first and second weighting means 22A and 22B. As for the calculated average picture level, it is possible to obtain one that is comparatively exact as compared with the first through third preferred embodiments shown in FIGS. 7 and 8.

Further, as described in the above-mentioned second preferred embodiment, it may be arranged that the first weighting means 22A in the structure as shown in FIG. 9 is also be replaced with the weighting means for performing the weighting according to the light emitting power rate of each color at the time of displaying the gray scale. Also in such an arrangement, as for the average picture level which is similarly calculated, it is possible to obtain one that is comparatively exact.

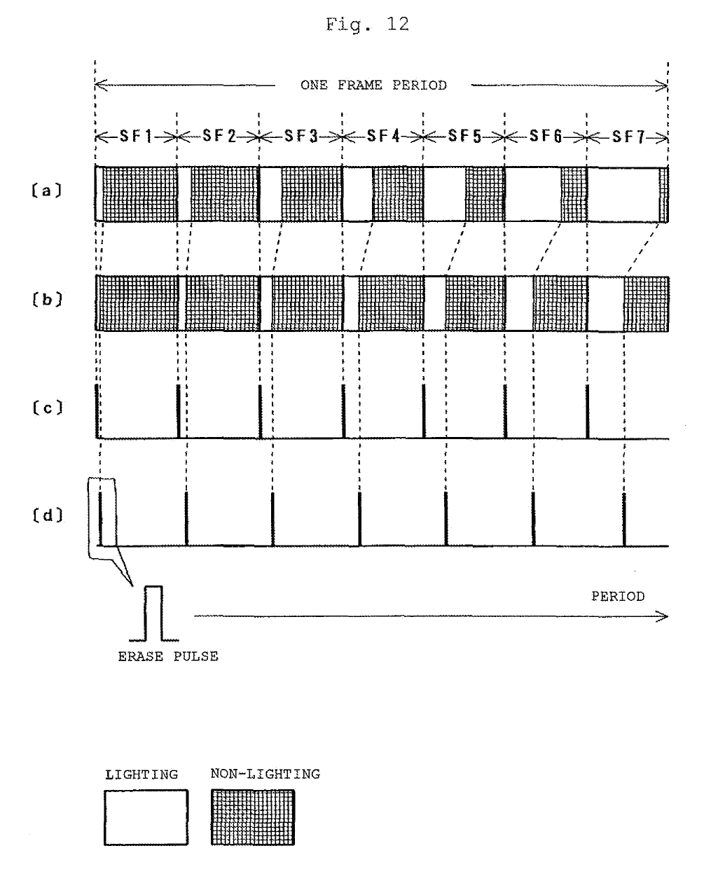

Then, a fifth preferred embodiment of the present invention will be described. FIGS. 10-13 show the fifth preferred embodiment, in which a drive apparatus for an active-matrix type display panel is arranged.

FIG. 10 shows the whole structure of the drive apparatus, in which a luminescence control circuit 101 is connected with an analog/digital (A/D) conversion circuit 102, an image memory 103, and a dimmer setting table 104. In the preferred embodiment as shown in this FIG. 10, it is arranged that the analog picture signal may be supplied to the luminescence control circuit 101 and the A/D conversion circuit 102. Based on the horizontal and vertical synchronizing signals in the analog picture signal, the above-mentioned luminescence control circuit 101 generates a clock signal CK for the above-mentioned A/D conversion circuit 102, and a write-in signal W and a read-out signal R for the above-mentioned image memory 103.

Based on the clock signal supplied from the luminescence control circuit 101, the above-mentioned A/D conversion circuit 102 samples the inputted analog signal and operates to convert this into image data for each pixel to be supplied to the image memory 103. The above-mentioned image memory 103 operates so that each pixel datum supplied from the A/D conversion circuit 102 may be written in the image memory 103 one by one according to the write-in signal W from the above-mentioned luminescence control circuit 101.

A frame memory is used as the above-mentioned image memory 103, and the writing of the data for one screen in the display panel to be described later is performed by the above-mentioned write-in operation. Then, in a situation where the writing of the data for one screen is completed, it operates to obtain proportions (lighting rates) of the pixels to be caused and controlled to emit light based on the above-mentioned image data written in the memory 103. In other words, the luminescence control circuit 101 also achieves the function as a lighting rate calculation means.

Based on the horizontal and vertical synchronizing signals in the above-mentioned picture signal, the above-mentioned luminescence control circuit 101 operates to generate a synchronization signal for a scanning driver 106, a data driver 107, and an erase driver 108 as a second scanning driver. Further, the luminescence control circuit 101 obtains the lighting rate of the pixel from the image data written in the above-mentioned memory 103, and operates to read the image data from the above-mentioned memory 103 according to the read-out signal R supplied from the luminescence control circuit 101.

Further, based on the above-mentioned lighting rate, the above-mentioned luminescence control circuit 101 refers to the above-mentioned dimmer setting table 104, and operates to generate a control signal for the data driver 107 and the erase driver 108. In addition, operation at this time of the data driver 107 and the erase driver 108 will be described in detail later.

Reference numeral 110 shown in FIG. 10 indicates the display panel in which a large number of pixels 111 each containing a light emitting element are arranged in a matrix pattern. Arranged at this display panel 110 are scanning lines 113, data lines 114, and erase signal lines 115 which are respectively connected to the above-mentioned scanning driver 106, the data driver 107, and the erase driver 108. The pixels 111 containing the above-mentioned light emitting element are respectively arranged at these intersections. In addition, it is arranged that a voltage for lighting and driving the pixel is supplied from the power supply circuit 109 through a power supply line 116 to each of the above-mentioned pixels 111.

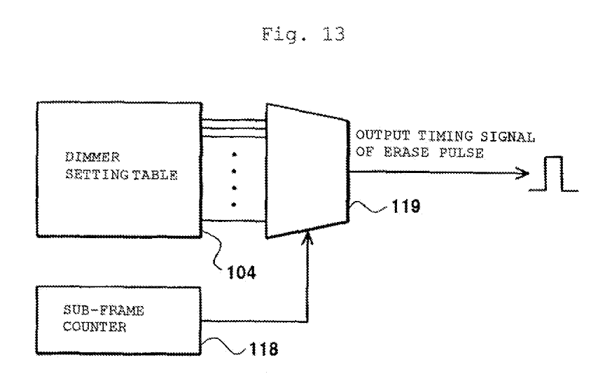

FIG. 11 shows a circuit structure corresponding to one pixel arranged at the above-mentioned display panel 110. This pixel 111 is arranged so that the data signal Vdata corresponding to the picture signal from the above-mentioned data driver 107 may be supplied to a source of TFT for control, i.e., a data write-in transistor Tr1, through the data line 114 arranged at the display panel.

It is arranged that a scanning signal Select (hereafter also referred to as a write-in pulse) may be supplied to a gate of the above-mentioned data write-in transistor Tr1 through the scanning line 113 connected to a scanning driver 106. A drain of the above-mentioned data write-in transistor Tr1 is connected to a gate of a lighting and driving TFT i.e., a lighting and driving transistor Tr2 and also connected to one terminal of the capacitor C1 (as electric capacitance) for holding electric charges.

Further, the source of the lighting and driving transistor Tr2 is arranged to be connected with the other terminal of the above-mentioned capacitor C1 and supplied with a drive voltage Vcc via a power supply line 116. The drain of the above-mentioned lighting and driving transistor Tr2 is connected to the anode terminal of the organic EL element E1 as a light emitting element, and the cathode terminal of this organic EL element E1 is connected to the reference potential point (ground).

Furthermore, it is arranged that a gate of an erase transistor Tr3 as TFT for erase is supplied with an erase signal Erase (also referred to as an erase pulse) from an erase driver through the erase signal line 115. A source and a drain of the erase transistor Tr3 are connected to terminals of the above-mentioned capacitor C1, respectively.

In addition, in the circuit structure of the pixel 111 as shown in FIG. 11, only the drive transistor Tr2 is constituted by a p-channel type TFT, and others are constituted by an n-channel type TFT. As shown in FIG. 10, a large number of the pixels 111 having the above-mentioned arrangement are disposed in a matrix pattern in row and column directions so as to constitute the display panel 110.

In the structure of the pixels 111 as shown in FIG. 11, the write-in pulse Select as a scanning signal is supplied to the gate of the control transistor Tr1 from the scanning driver 106 in an address period. Thus, the current corresponding to the data signal Vdata supplied from the data driver 107 flows into the capacitor C1 through the source and drain of the control transistor Tr1, and the capacitor C1 is charged. Then the charge voltage is supplied to the gate of the drive transistor Tr2, the transistor Tr2 causes the current corresponding to its gate voltage and the drive voltage Vcc supplied to the source to flow into the above-mentioned EL element E1, whereby the EL element E1 emits light.

When the application of the above-mentioned write-in pulse to the gate of the above-mentioned control transistor Tr1 is stopped, the transistor Tr1 is so-called cut off. However, the gate voltage of the drive transistor Tr2 is held by the electric charge accumulated in the capacitor C1, whereby the drive current to the EL element E1 is maintained. Therefore, the EL element E1 can continue a lighting state corresponding to the above-mentioned data signal Vdata in a period (one sub-frame period as will be described later) until the next address operation.

On the other hand, in the middle of the lighting period of the above-mentioned EL element E1 (in the middle of one sub-frame period), the erase pulse Erase which causes the erase transistor Tr3 to turn on is supplied from the above-mentioned erase driver 108, whereby the electric charge charged in the capacitor C1 can be eliminated (discharged) instantaneously. As a result, the drive transistor Tr2 is in a cut-off state, and the EL element E1 is turned off immediately. In other words, the lighting period in one sub-frame of the EL element E1 is controlled by controlling an output timing of the erase pulse Erase from the erase driver 108, so that multi-gradation expression can be realized.

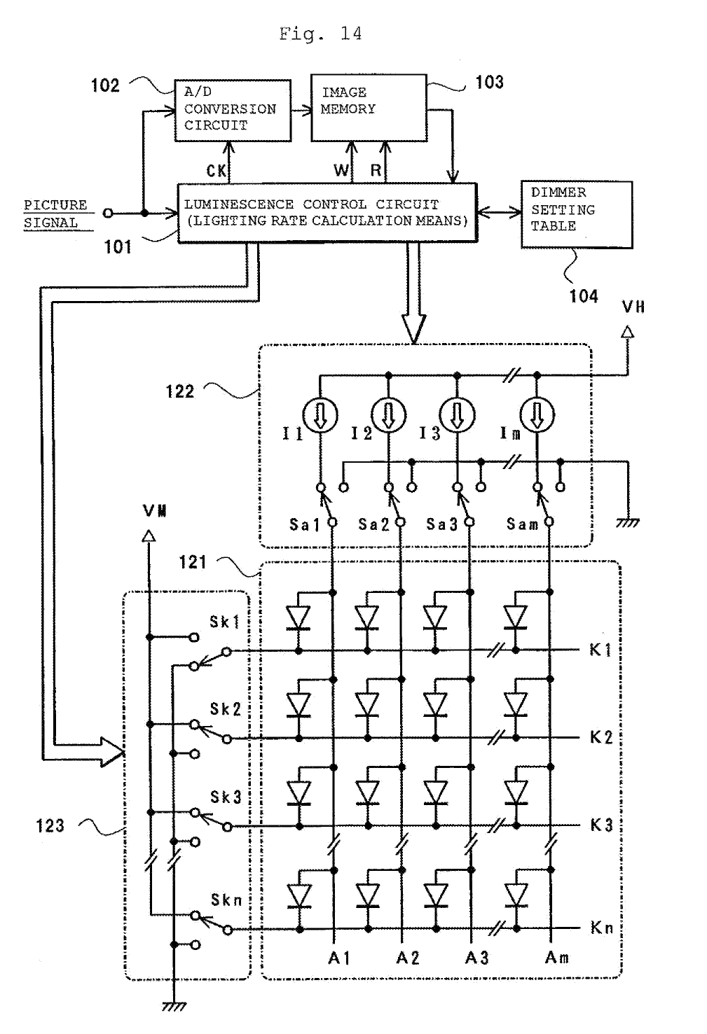

FIG. 12 is for explaining the PLE control carried out by means of the structure as shown in FIGS. 10 and 11. For realizing this PLE control, in the present embodiment, a gradation control means is employed which divides one frame (period) into a plurality of sub-frames to realize gradation control by selecting the sub-frames and by summing the lighting periods of the pixel within one frame period.

In other words, FIG. 12 shows an example in which, in order to simplify the explanation, one frame (period) is divided into seven sub-frames (SF1-SF7) to realize eight gradation expressions (100% non-lighting can also be considered as one gradation to provide 7+1 gradation expressions) by selecting each sub-frame in one-frame period.

FIGS. 12(a) and 12(b) show an example in which the rates (proportions) of the lighting period and the non-lighting period for each sub-frame are controlled according to the lighting rate (proportion) of the above-mentioned pixel 111 arranged at the display panel 110. FIG. 12(a) shows the case where the rate of the lighting period for each sub-frame is large, and FIG. 12(b) shows the case where the rate of the lighting period for each sub-frame is small. In addition, both FIGS. 12(a) and 12(b) show an example where gamma values of the gradation characteristics are the same, and dimmer characteristics are changed.

Now, when the lighting rate of the pixel is low, lighting control as shown in FIG. 12(a) is performed. When the lighting rate of the pixel is high, it is controlled so that the lighting control as shown in FIG. 12(b) is performed. In short, according to a degree of the lighting rate of the pixel, the rate (proportion) of the lighting period for each sub-frame is controlled to change between those in FIGS. 12(a) and 12(b). Thus, when the lighting rate of the pixel is considerably high, and a total sum of the lighting periods of the pixel within one frame period is reduced, and a drive current (value) supplied to each pixel can be controlled.

FIG. 12(c) and FIG. 12(d) are for explaining a generating timing of the above-mentioned write-in pulse and erase pulse in the case of realizing the lighting control as shown in FIG. 12(b). In other words, in the example as shown in FIG. 12, the write-in pulse shown in FIG. 12(c) takes place in synchronization with start of each sub-frame, whereby the pixel is caused to be the lighting state. The erase pulse as shown FIG. 12(d) takes place in the middle of the lapse of time during the sub-frame period, whereby the pixel is changed into a non-lighting state.

Here, when trying to realize the gradation “8” (for example), a series of lighting patterns as shown in FIG. 12(a) or FIG. 12(b) are carried out for the pixel in one frame period. When trying to realize the gradation “5” (for example), lighting drive operation is performed in the periods Sf1-Sf4 as shown in FIG. 12(a) or FIG. 12(b). All the periods Sf5-Sf7 thereafter of each sub-frame are caused to be a turn-off state. Thus, the emission brightness can be obtained according to the total sum of the lighting periods of the pixel in one frame period.

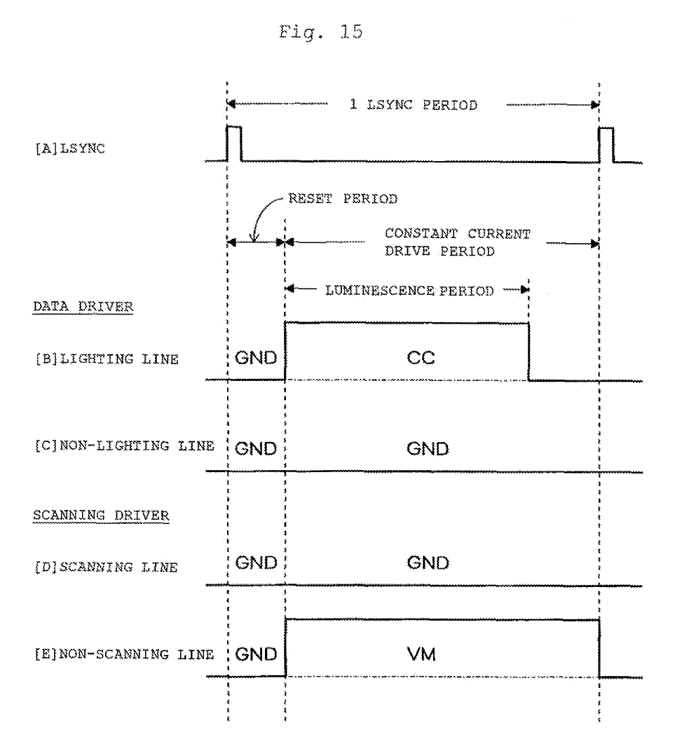

The erase pulse as shown in FIG. 12(d) can be generated according to the structure shown in FIG. 13 as will be described below. Reference numeral 118 in FIG. 13, reference numeral 119, and reference numeral 104 respectively indicate a sub-frame counter, a logical operation unit, and the dimmer setting table as described with reference to FIG. 10. In other words, as shown in FIG. 10, it is arranged that the above-mentioned dimmer setting table 104 is caused to be external to the luminescence control circuit 101, and the sub-frame counter 118 and the logical operation unit 119 are built in the luminescence control circuit 101.

Corresponding to the above-mentioned lighting rate, the lighting period for each sub-frame is stored in the above-mentioned dimmer setting table 104 as a parameter. When the number of a sub-frame to be lit and controlled is supplied from the sub-frame counter 118 to the logical operation unit 119, the logical operation unit 119 accesses the table 104 and operates so that the output timing signal of the above-mentioned erase pulse may be generated based on the parameter of the lighting time stored corresponding to the number of the sub-frame.

This is generated as the output timing signal of the erase pulse for every sub-frame each corresponding to the lighting rate of the pixel as shown in FIG. 12(d). This timing signal is supplied to the above-mentioned erase driver 108 and operates so that the erase pulse may be outputted from the erase driver 108 for each sub-frame as described above.

According to the fifth preferred embodiment as described above, it operates so that the emission brightness of each pixel may be controlled based on the lighting rate of the pixel in the situation where a specific gamma characteristic is provided, to thereby it operates so that the emission brightness of each pixel may be inhibited when the lighting rate is high.

Therefore, the maximum drive current supplied from the power supply circuit to the display panel can be controlled, thus solving the problem that the size of each component used for the power supply circuit and the whole power supply circuit are large.

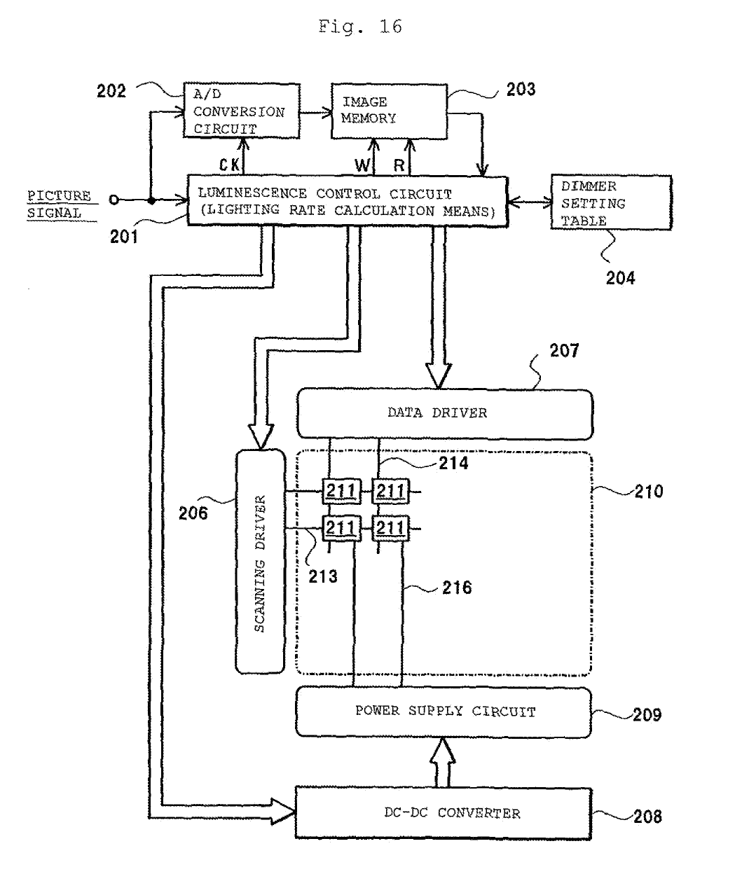

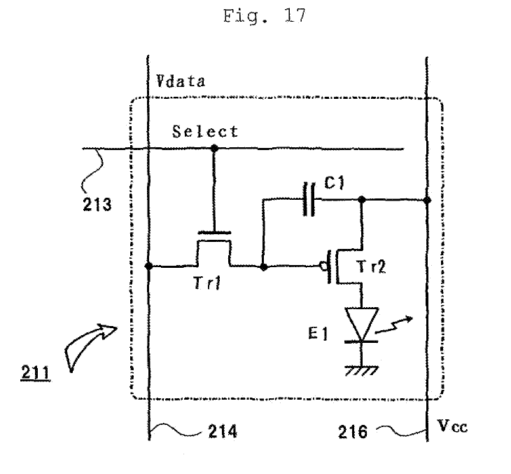

FIGS. 14 and 15 show the sixth preferred embodiment of the present invention, and show a drive apparatus for a passive matrix type display panel. In addition, in the circuit structure as shown in FIG. 14, parts performing the same functions as the already described parts in FIG. 10 are given identical reference signs. Accordingly, the description of these will not be repeated.

Anode lines A1-Am as m data lines are arranged vertically (in a column direction) at a display panel 121 as shown in FIG. 14. Cathode lines K1-Kn as n scanning lines are arranged horizontally (in a row direction). At each of their intersections (m×n positions in total), the organic EL element as a light emitting element as indicated by a symbol representative of a diode is connected and arranged between each anode line and scanning line. Each of the anode lines A1-Am is connected with an anode-line drive circuit 122 as a data driver, and each of the cathode lines K1-Kn is connected with a cathode-line scanning circuit 123 as a scanning driver, thus being driven respectively.

The above-mentioned anode-line drive circuit 122 is provided with constant current sources I1-Im as lighting driving power sources which operate by means of a drive voltage VH, and drive switches Sa1-Sam. It operates such that the drive switches Sa1-Sam are connected to the above-mentioned constant current sources I1-Im side, so that current from the constant current sources I1-Im may be supplied to the individual EL elements arranged at intersections where the anode lines intersect with the cathode lines. Further, when not supplying the current from the constant current sources I1-Im to the individual EL elements, the above-mentioned drive switches Sa1-Sam are arranged so that each of the above-mentioned anode lines can be connected to the ground potential as a non-lighting driving power supply.

Further, the above-mentioned cathode-line scanning circuit 123 is provided with scanning switches Sk1-Skn corresponding to the respective cathode lines K1-Kn. The switches operate so that either of a reverse bias voltage source VM which functions as a non-scanning selection potential and prevents cross talk luminescence or the ground potential which functions as the scanning selection potential may be connected to the corresponding cathode line. Thus, the switches operate so that each of the above-mentioned EL elements may selectively be caused to emit light by connecting the constant current sources I1-Im to the desired anode lines A1-Am, while setting cathode lines as the ground potential at predetermined time intervals.

In the preferred embodiment as shown in FIG. 14, a scanning synchronization signal is supplied from the luminescence control circuit 101 to the cathode-line scanning circuit 123, whereby operation of setting each of the cathode lines K1-Kn as the ground potential (scanning selection potential) one by one is repeated. Further, in synchronization with the scan of each of the cathode lines K1-Kn, image data are supplied from the luminescence control circuit 101 to the anode-line drive circuit 122. Therefore, each of the above-mentioned EL elements is turned on selectively, and a picture based on the picture signal is displayed on the display panel 121.

From the image data written in the image memory 103, the above-mentioned luminescence control circuit 101 calculates a lighting rate of the EL element as the display pixel arranged at the display panel 121, and refers to the dimmer setting table 104 based on this lighting rate. It reads brightness control data corresponding to the lighting rate from the above-mentioned dimmer setting table 104, and operates to control a supply period of the constant current supplied from the constant current sources I1-Im in the anode-line drive circuit 122 to an EL element to be lit.

In other words, according to the lighting rate of the pixel in this embodiment, the supply period of the constant current supplied from each of the above-mentioned constant current sources I1-Im to the EL element to be lit is controlled for each scanning period, whereby it operates so that the control of the emission brightness of each pixel may be realized. In particular, when the lighting rate of the pixel is high, the control is such that the supply period of the constant current for each scanning period supplied from each of the above-mentioned constant current sources I1-Im to the EL element which constitutes each pixel may be short, whereby the emission brightness of each pixel in a situation where the lighting rate of the pixel is high is inhibited.

FIG. 15 is a timing chart showing an example in which the supply period of the constant current supplied to the EL element to be lit is controlled for each scanning period. The example as shown in this FIG. 15 illustrates luminescence drive operation of the EL element containing a reset period which nulls the amount of electric charges charged in a parasitic capacitance of the EL element which constitutes each pixel.

FIG. 15(A) shows the scanning synchronization signal, and the reset period and a constant current drive period are set up in this example in synchronization with the above-mentioned scanning synchronization signal. FIG. 15(B) and FIG. 15(C) show potentials applied to a lighting line and a non-lighting line at the anode-line connected to the data driver (anode-line drive circuit) 122 in each of the above-mentioned periods. Further, FIG. 15(D) and FIG. (E) show potentials applied to the scanning line and the non-scanning line at the cathode line connected to the scanning driver (cathode-line scanning circuit) 123 in each of the above-mentioned periods

In the reset period as shown in FIG. 15, the above-mentioned drive switches Sa1-Sam provided for the data driver 122 are controlled to supply the ground potential GND to the anode lines (lighting lines) corresponding to the EL elements to be lit and driven, as shown in FIG. 15(B). Further, control is carried out so as to supply the ground potential GND also to the anode lines (non-lighting lines) corresponding to the EL elements which are not to be lit and driven, as shown in FIG. 15(C).

On the other hand, as shown in FIGS. 15(D) and 15(E), the scanning driver 123 in the above-mentioned reset period is controlled by the scanning switches sk1-skn provided therein to respectively supply the ground potential GND to the cathode lines to be scanned (scanning lines) and the cathode lines not to be scanned (non-scanning lines). Thus, the anode and cathode electrodes of each of the organic EL elements arranged at the display panel 121 are respectively connected to the ground potential GND which is a reset potential, so that a reset action (GND-GND reset) by which the electric charge in the parasitic capacitance of each EL element is nulled is performed.

Further, in the constant current drive period which is a period when the EL element can emit light, as shown in FIG. 15(B), constant current (CC) is supplied by the above-mentioned drive switches Sa1-Sam from the constant current sources I1-Im as the lighting driving power supply to the anode lines (lighting lines) corresponding to the EL elements to be caused to emit light. Further, as shown in FIG. 15(c), the anode lines (non-lighting lines) corresponding to the EL elements not to be lit are set to the ground potential GND as a non-lighting driving power supply.

On the other hand, the cathode driver 123 in the above-mentioned constant current drive period is controlled such that cathode lines (scanning lines) are set as the ground potential GND which is the scanning selection potential as shown in FIG. 15(D) by means of the above-mentioned scanning switches sk1-skn provided for the driver and the reverse bias voltage VM which is a non-scanning selection potential is applied to the cathode lines not to be scanned (non-scanning lines) as shown in FIG. 15(E).

Thus, being connected with the scanning lines, the EL elements to be lit are supplied with lighting driving current from the constant current sources I1-Im so as to be in the lighting state and the reverse bias voltage VM is applied to the cathode lines in a non-scanning state, so that each of the EL elements connected to the intersection of the anode line to be lit and the cathode line which is not selected for scanning may be prevented from emitting light due to cross talk.

At this time, based on the brightness control data corresponding to the above-mentioned lighting rate from the luminescence control circuit 101 as shown in FIG. 14, the supply period (luminescence period) of the constant current (CC) as light-emitting drive current applied from the constant current sources I1-Im to the EL element whose light emission should be controlled is controlled. This is realized, in the above-mentioned constant current period for each scan, by adjusting a timing to switch the above-mentioned drive switches Sa1-Sam from the constant current sources I1-Im to the ground potential GND.

When the lighting rate of the pixel is high according to the above-mentioned operation, the supply period of the constant current in one scanning period is controlled to be short and the emission brightness of each pixel is inhibited. Therefore, when the lighting rate of the pixel is high also in the preferred embodiment as shown in FIG. 14, the maximum drive current supplied from the power supply circuit to the display panel can be inhibited, and it is possible to solve the problem that the size of each component used for the power supply circuit and the whole power supply circuit are large.

For convenience of description, in the fifth preferred embodiment in accordance with the present invention as shown in FIGS. 10-13, although the example is shown in which the gradation control is carried out in eight steps, practical gradation control may suitably employ 32 steps, 64 steps etc., for example.

Further, in addition to the above-mentioned fifth preferred embodiment, also in the sixth preferred embodiment as shown in FIGS. 14 and 15, although the example is illustrated using the organic EL element as the light emitting element which constitutes each pixel, it is also possible to obtain similar operational effects, even if another type of light emitting element whose emission brightness depends on the drive current is used. Furthermore, in the above-mentioned preferred embodiments, although the proportions (lighting rate) of the pixels to be lit and controlled are obtained based on the image data written in the image memory 103, it is possible to calculate an average brightness level from the above-mentioned image data.

Next, a seventh preferred embodiment of the present invention will be described. FIGS. 16-18 show the seventh preferred embodiment, and this constitutes a drive apparatus for an active-matrix type display panel.

FIG. 16 shows the whole structure of the drive apparatus. A luminescence control circuit 201 is connected with an analog/digital (A/D) conversion circuit 202, an image memory 203, and a dimmer setting table 204. In the preferred embodiment as shown in this FIG. 16, the analog picture signal is arranged to be supplied to the luminescence control circuit 201 and the A/D conversion circuit 202. Based on the horizontal and vertical synchronizing signals in the analog picture signal, the above-mentioned luminescence control circuit 201 generates a clock signal CK for the above-mentioned A/D conversion circuit 202, and a write-in signal W and a read-out signal R for the above-mentioned image memory 203.

Based on the clock signal supplied from the luminescence control circuit 201, the above-mentioned A/D conversion circuit 202 samples the inputted analog signal and operates to convert this into image data for each pixel to be supplied to the image memory 203. The above-mentioned image memory 203 operates so that each pixel datum supplied from the A/D conversion circuit 202 may be written in the image memory 203 one by one according to the write-in signal W from the above-mentioned luminescence control circuit 201.

A frame memory is used as the above-mentioned image memory 203, and the writing of the data for one screen in the display panel to be described later is performed by the above-mentioned write-in operation. Then, in a situation where the writing of the data for one screen is completed, it operates to obtain proportions (lighting rates) of the pixels to be caused and controlled to emit light based on the above-mentioned image data written in the memory 203. In other words, the luminescence control circuit 201 also achieves the function as the lighting rate calculation means.

Based on the horizontal and vertical synchronizing signals in the above-mentioned picture signal, the above-mentioned luminescence control circuit 201 operates to generate a synchronization signal for a scanning driver 206 and a data driver 207. Further, the luminescence control circuit 201 obtains the lighting rate of the pixel from the image data written in the above-mentioned memory 203, and operates to read the image data from the above-mentioned memory 203 according to the read-out signal R supplied from the luminescence control circuit 201.

Further, based on the above-mentioned lighting rate, the above-mentioned luminescence control circuit 201 refers to the above-mentioned dimmer setting table 204, and operates to read brightness control information corresponding to the lighting rate and to realize the above-mentioned PLE control by controlling the lighting driving voltage supplied to the pixel of the display panel to be described later. For this reason, in the preferred embodiment as shown in FIG. 16, a DC-DC converter 208 whose output voltage is controlled based on the above-mentioned lighting rate is provided.

Reference numeral 210 shown in FIG. 16 indicates the display panel in which a large number of pixels 211 each containing a light emitting element are arranged in a matrix pattern. Arranged orthogonally to each other at this display panel 210 are scanning lines 213 and data lines 214 which are respectively connected to the above-mentioned scanning driver 206 and the data driver 207. The pixels 211 containing the above-mentioned light emitting element are respectively arranged at these intersections.

In addition, it is arranged that a voltage for lighting and driving the pixel is supplied to each of the above-mentioned pixels 211 from a power supply circuit 209 through a power supply line 216 and that the power supply circuit 209 is supplied with an output voltage from the above-mentioned DC-DC converter 208.

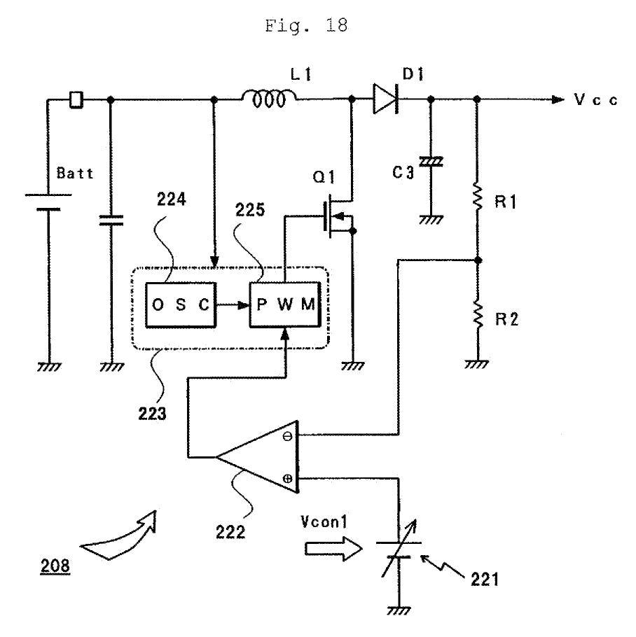

FIG. 17 shows a circuit structure corresponding to one pixel arranged at the above-mentioned display panel 210, and this shows the most fundamental pixel structure in the case of using the EL element as the light emitting element. This pixel 211 is arranged so that the data signal Vdata corresponding to the picture signal from the above-mentioned data driver 207 may be supplied to the source of TFT for control, i.e., the data write-in transistor Tr1, through the data line 214 arranged at the display panel.

It is arranged that the scanning signal Select (hereafter also referred to as write-in pulse) may be supplied to the gate of the above-mentioned data write-in transistor Tr1 through the scanning line 213 connected to the scanning driver 206. The drain of the above-mentioned data write-in transistor Tr1 is connected to the gate of the lighting and driving TFT i.e., the lighting and driving transistor Tr2 and also connected to one terminal of the capacitor C1 for holding electric charges.

Further, the source of the lighting and driving transistor Tr2 is arranged to be connected with the other terminal of the above-mentioned capacitor C1 and supplied with the drive voltage Vcc via the power supply line 216. The drain of the above-mentioned lighting and driving transistor Tr2 is connected to the anode terminal of the organic EL element E1 as the light emitting element, and the cathode terminal of this organic EL element E1 is connected to the reference potential point (ground).

In addition, in the circuit structure of the pixel 211 as shown in FIG. 17, the data write-in transistor Tr1 is constituted by the n-channel type TFT, and the drive transistor Tr2 is constituted by the p-channel type TFT. As shown in FIG. 16, a large number of the thus arranged pixels 211 are arranged in a matrix pattern in the row and column directions so as to constitute the display panel 210.

In the structure of the pixel 211 as shown in FIG. 17, the write-in pulse Select as the scanning signal is supplied from the scanning driver 206 to the gate of the control transistor Tr1 in the address period. At this time, when the data signal Vdata supplied from the data driver 207 is a datum for causing the pixel to turn on, the current corresponding to the data signal Vdata flows into the capacitor C1 through the source and drain of the control transistor Tr1, and the capacitor C1 is charged.

Then, the charge voltage is supplied to the gate of the drive transistor Tr2, the transistor Tr2 causes the current corresponding to its gate voltage and the drive voltage Vcc supplied to the source to flow into the above-mentioned EL element E1, whereby the EL element E1 emits light.

If the application of the above-mentioned write-in pulse to the gate of the above-mentioned control transistor Tr1 is stopped, the transistor Tr1 is so-called cut off. However, the gate voltage of the drive transistor Tr2 is held by the electric charge accumulated in the capacitor C1, whereby the drive current to the EL element E1 is maintained.

Thus, the EL element E1 can continue the lighting state corresponding to the above-mentioned data signal Vdata in the period until the next address operation. Therefore, in the above-mentioned address period, according to the data signal Vdata supplied from the data driver 207, the lighting or turning-off of the pixel is controlled, to thereby realize the gradation control where the lighting period in a unit period of each pixel is controlled individually.

On the other hand, as already described, the luminescence control circuit 201 as shown in FIG. 16 obtains the lighting rate of the pixel from the image data written in the image memory 203, and refers to the dimmer setting table 204 based on this lighting rate. Reading the brightness control data corresponding to the lighting rate from the table 204, it operates to generate a control voltage Vcon1 to be supplied to the above-mentioned DC-DC converter 208. In other words, when the lighting rate of the pixel is high, it operates to generate the control voltage Vcon1 for reducing the output voltage of the above-mentioned DC-DC converter 208, thus operating to inhibit the emission brightness of each pixel in the situation where the lighting rate of the pixel is high.

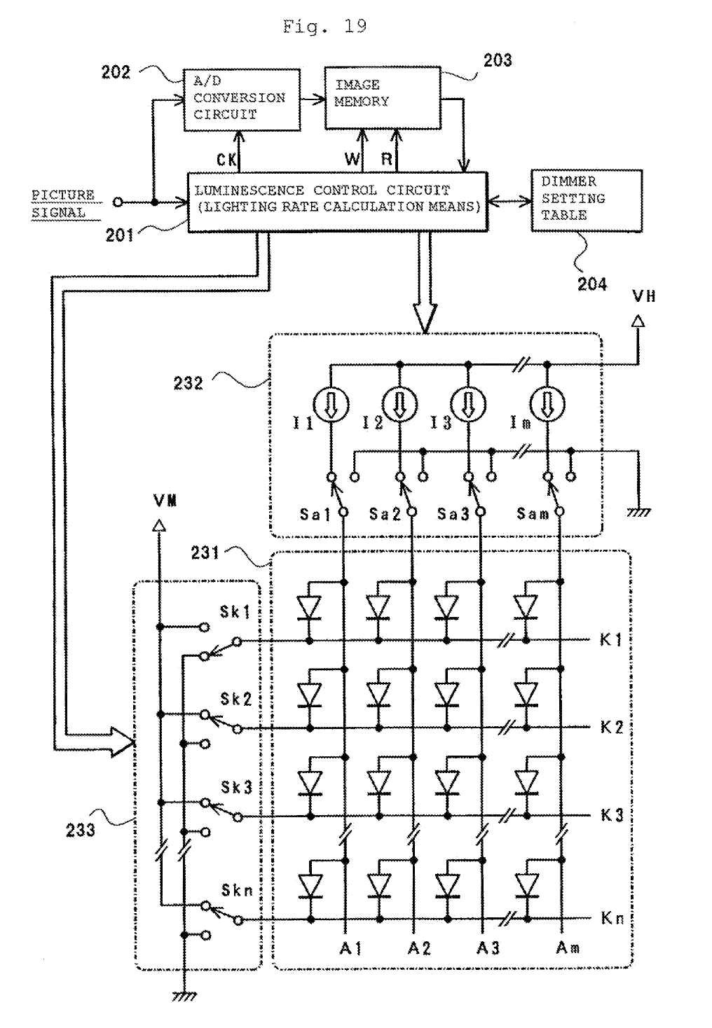

FIG. 18 is for explaining a particular example of the DC-DC converter as indicated by reference numeral 208 in FIG. 16. In other words, according to the control voltage Vcon1 from the luminescence control circuit 201 as shown in FIG. 16, the output value of a variable voltage source 221 is variably controlled. And the output of the above-mentioned variable voltage source 221 is arranged so as to be supplied to one input terminal (non-inversing input terminal) in an error amplifier 222. Furthermore, the other input terminal (inversing input terminal) in the error amplifier 222 is arranged to be supplied with a voltage-divided output by means of resistance elements R1 and R2 which divide the output voltage Vcc at the DC-DC converter. Therefore, an output voltage value in the error amplifier 222 is an output equivalent to a difference between the above-mentioned control voltage Vcon1 and the output Vcc in the above-mentioned DC-DC converter.

In the structure as shown in FIG. 18, a booster-type DC-DC converter is used, and the output in the above-mentioned error amplifier 222 is arranged to be supplied to a switching-signal generation circuit 223. This switching-signal generation circuit 223 is provided with a reference sawtooth-wave (triangular wave) signal oscillator 224 and a PWM (pulse width modulation) circuit 225. A comparator (not shown) is provided for the above-mentioned PWM circuit 225. This comparator is supplied with the output from the above-mentioned error amplifier 222 and a sawtooth wave (triangular wave) from the reference sawtooth-wave signal oscillator 224, so that a PWM signal is generated from the PWM circuit 225.

A pulse signal generated by way of PWM from the above-mentioned PWM circuit 225 is arranged to be supplied to a gate of a power FET Q1, so as to switch the FET Q1. In other words, power energy from a battery Batt is accumulated in an inductor L1 by switching ON the above-mentioned FET Q1. On the other hand, as the FET Q1 is subjected to OFF operation, the power energy accumulated in the above-mentioned inductor is accumulated in a capacitor C3 via a diode D1.

By repeating the on/off operation of the above-mentioned FET Q1, the boosted (rise in voltage) DC output can be obtained as a terminal voltage of the capacitor C3, so as to be the output voltage Vcc from the converter. As described above, this output voltage Vcc is divided by the resistance elements R1 and R2, and fed back to the error amplifier 222, so that the output voltage Vcc may be controlled based on the control voltage Vcon1 according to the lighting rate of the pixel as a result.

As such, according to the seventh preferred embodiment as shown in FIGS. 16-18, it operates so that the drive voltage (value) supplied to each pixel is reduced especially when the lighting rate of the pixel is high. Therefore, it operates so that the emission brightness of each pixel in the situation where the lighting rate is high is inhibited, and accordingly the maximum drive current supplied from the power supply circuit to the display panel is inhibited. Thus, it is possible to solve the problem that the size of each component used for the power supply circuit and the whole power supply circuit are large.

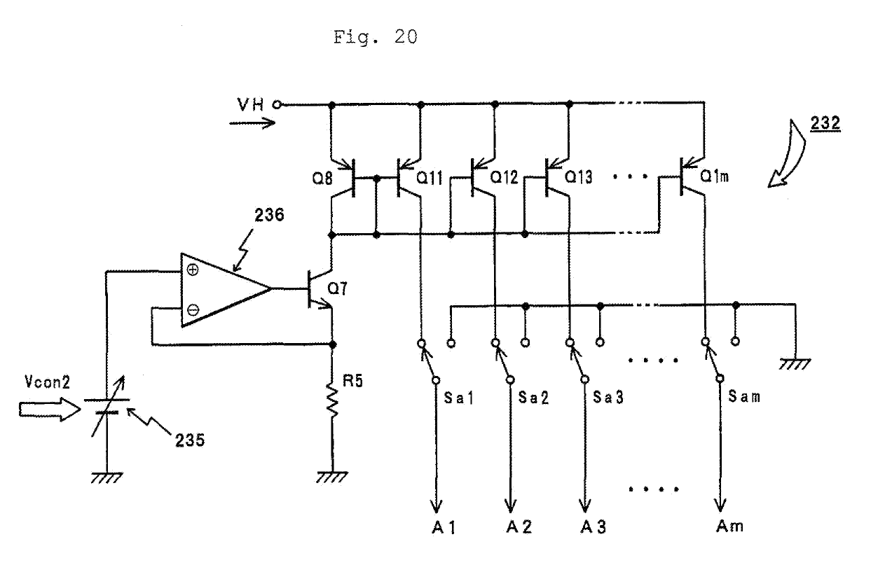

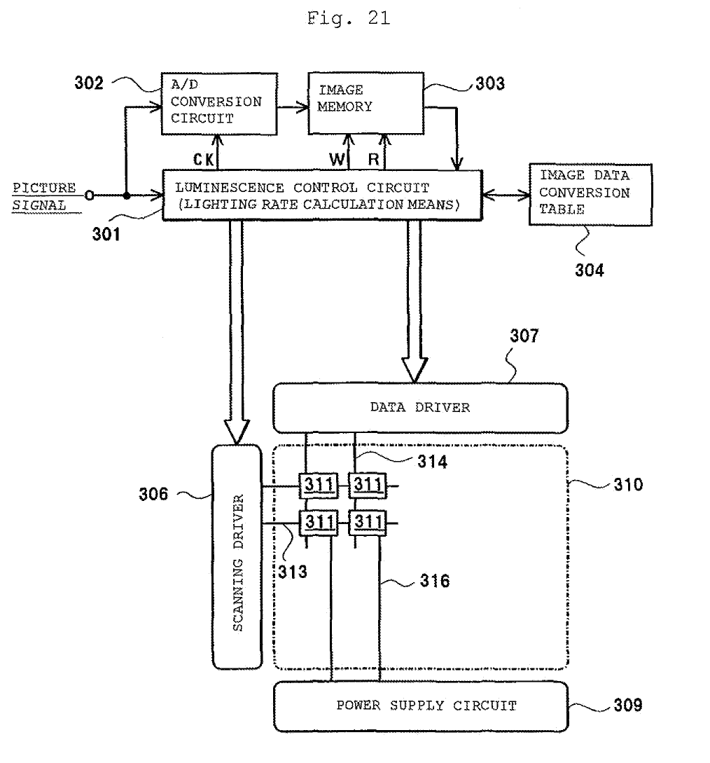

FIGS. 19 and 20 show an eighth preferred embodiment of the present invention, and show a drive apparatus for a passive matrix type display panel. A structure as shown with reference numerals 201-204 in FIG. 19 achieves the same function as the structure shown in FIG. 16, as already described. Therefore, the detailed description of these will not be repeated.

The anode lines A1-Am as m data lines are arranged vertically (in a column direction) at a display panel 231 as shown in FIG. 19, and the cathode lines K1-Kn as n scanning lines are arranged horizontally (in a row direction). In positions where the anode lines and the cathode lines intersect respectively (m×n positions in total), the organic EL elements as the light emitting elements indicated by diode symbols are arranged and respectively connected between the anode lines and the scanning lines. Further, each of the anode lines A1-Am is connected to an anode-line drive circuit 232 as the data driver, and each of the cathode lines K1-Kn is connected to a cathode-line scanning circuit 233 as the scanning driver, so as to be driven respectively.

The above-mentioned anode-line drive circuit 232 is provided with the constant current sources I1-Im which operate by means of the drive voltage VH, and the drive switches Sa1-Sam. It operates such that the drive switches Sa1-Sam are connected to the above-mentioned constant current sources I1-Im side, so that the current from the constant current sources I1-Im may be supplied to the individual EL elements arranged at the intersections where the anode lines intersect with the cathode lines. Further, when not supplying the current from the constant current sources I1-Im to the individual EL elements, the above-mentioned drive switches Sa1-Sam are arranged so that each of the above-mentioned anode lines can be connected to the ground potential as the reference potential point.

Further, the above-mentioned cathode-line scanning circuit 233 is provided with scanning switches Sk1-Skn corresponding to the respective cathode lines K1-Kn. The switches operate so that either of the reverse bias voltage source VM which functions as the non-scanning selection potential and prevents cross talk luminescence or the ground potential which functions as the scanning selection potential may be connected to the corresponding cathode line. Thus, the switches operate so that each of the above-mentioned EL elements may selectively be caused to emit light by connecting the constant current sources I1-Im to the desired anode lines A1-Am, while setting cathode lines as the reference potential point (ground potential) at predetermined time intervals.

In the preferred embodiment as shown in FIG. 19, the scanning synchronization signal is supplied from the luminescence control circuit 201 to the cathode-line scanning circuit 233, whereby the operation of setting each of the cathode lines K1-Kn as the ground potential (scanning selection potential) one by one is repeated. Further, in synchronization with the scanning synchronization signal, image data for each scanning line are supplied from the luminescence control circuit 201 to the anode-line drive circuit 232. Therefore, each of the above-mentioned EL elements is turned on selectively, and a picture based on the picture signal is displayed on the display panel 231.

From the image data written in the image memory 203, the above-mentioned luminescence control circuit 201 calculates a lighting rate of the EL element as the display pixel arranged at the display panel 231, and refers to the dimmer setting table 204 based on this lighting rate. It reads brightness control data corresponding to the lighting rate from the above-mentioned dimmer setting table 204, and operates to control the constant current value from the constant current sources I1-Im in the anode-line drive circuit 232.

In other words, when the lighting rate of the pixel is high, it operates to inhibit the drive current (value) supplied from the above-mentioned constant current sources I1-Im to the EL elements which constitute the respective pixels, whereby the emission brightness of each pixel in a situation where the lighting rate of the pixel is high is inhibited.

FIG. 20 shows a more particular circuit structure of the anode-line drive circuit 232 as shown in FIG. 19. FIG. 20 shows a particular example in which the drive current (value) of the EL element supplied from the constant current sources I1-Im to the anode lines A1-Am as the data lines is controlled according to the above-mentioned lighting rate. In other words, in the structure as shown in FIG. 20, current value control data outputted according to the lighting rate are supplied from the above-mentioned luminescence control circuit 201 to a variable voltage source as shown by reference numeral 235 as Vcon2, and this is inputted into the non-inversing input terminal of an operational amplifier 236.

Further, an output terminal of the operational amplifier 236 is connected with a base electrode of an npn-type transistor Q7. An emitter electrode of the above-mentioned transistor Q7 is connected with the inversing input terminal of the operational amplifier 236, and also connected with the ground potential GND through a resistor R5. In other words, the above-mentioned operational amplifier 236 and the transistor Q7 constitute a voltage/current conversion means, and operate to vary an amount of current which flows into the transistor Q7 according to the current value control data Vcon2 from the above-mentioned luminescence control circuit 201.

On the other hand, emitter and collector electrodes of a pnp-type transistor Q8 are connected between the above-mentioned drive voltage source VH and a collector electrode of the above-mentioned transistor Q7. It is arranged that the base and collector electrodes of the above-mentioned transistor Q8 are short-circuited and each base electrode of pnp-type transistors Q11-Q1m is similarly supplied with a base potential of the above-mentioned transistor Q8.

Further, an emitter electrode of each of the above-mentioned transistors Q11-Q1m is connected to the above-mentioned drive voltage source VH, so that a current mirror circuit is arranged in which the transistor Q8 serves as the current source on the control side and each of the transistors Q11-Q1m serves as the current source on the side to be controlled.

Therefore, collector current of the transistor Q8 which functions as the current source on the control side is variably controlled by the current value control data Vcon2 as indicated by the above-mentioned variable voltage source 235, so that the collector current in each of the transistors Q11-Q1m is each variably controlled. In short, the above-mentioned transistors Q11-Q1m respectively function as the constant current sources I1-Im as shown in FIG. 19. The collector current in each of the transistors Q11-Q1m operates to be supplied to a respective one of the anode lines A1-Am as the data lines through the drive switches Sa1-Sam.

According to the eighth preferred embodiment shown in FIGS. 19 and 20 as described above, it operates so that the drive current (value) supplied to each pixel is inhibited especially when the lighting rate of the pixel is high. Therefore, the emission brightness of each pixel in the situation where the lighting rate is high is inhibited, and it is possible to obtain operational effects similar to those in the seventh preferred embodiment shown in FIGS. 16-18, as already described.

In addition, in the above-described seventh and eighth preferred embodiments, although the example is illustrated using the organic EL element as the light emitting element which constitutes each pixel, it is also possible to obtain similar operational effects, even if another type of light emitting element whose emission brightness depends on the drive current or the drive voltage is used. Furthermore, in the above-mentioned preferred embodiments, although the proportions (lighting rate) of the pixels to be lit and controlled are obtained based on the image data written in the image memory 203, it is possible to calculate an average brightness level from the above-mentioned image data.

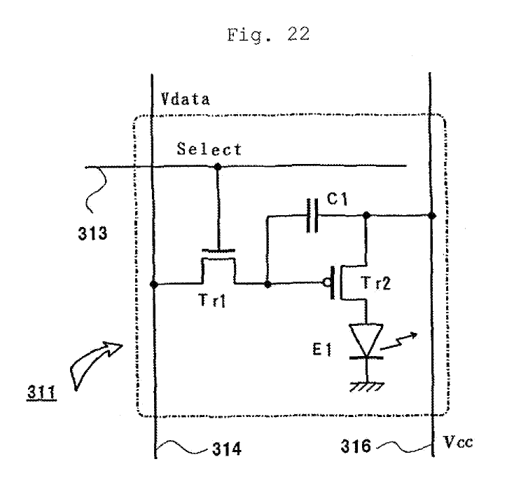

Next, a ninth preferred embodiment of the present invention will be described. FIGS. 21-23 show the ninth preferred embodiment, and this constitutes a drive apparatus for an active-matrix type display panel.

FIG. 21 shows the whole structure of the drive apparatus. A luminescence control circuit 301 is connected with an analog/digital (A/D) conversion circuit 302, an image memory 303, and an image data conversion table 304. In the preferred embodiment as shown in this FIG. 21, the analog picture signal is arranged to be supplied to the luminescence control circuit 301 and the A/D conversion circuit 302. Based on the horizontal and vertical synchronizing signals in the analog picture signal, the above-mentioned luminescence control circuit 301 generates a clock signal CK for the above-mentioned A/D conversion circuit 302, and a write-in signal W and a read-out signal R for the above-mentioned image memory 303.

Based on the clock signal supplied from the luminescence control circuit 301, the above-mentioned A/D conversion circuit 302 samples the inputted analog signal and operates to convert this into pixel data for each pixel to be supplied to the image memory 303. The above-mentioned image memory 303 operates so that each pixel datum supplied from the A/D conversion circuit 302 may be written in the image memory 303 one by one according to the write-in signal W from the above-mentioned luminescence control circuit 301.

A frame memory is used as the above-mentioned image memory 303, and the writing of the data for one screen in the display panel to be described later is performed by the above-mentioned write-in operation. Then, in a situation where the writing of the data for one screen is completed, it operates to obtain proportions (lighting rates) of the pixels to be caused and controlled to emit light based on the above-mentioned image data written in the memory 303. In other words, the luminescence control circuit 301 also achieves the function as the lighting rate calculation means.

Based on the horizontal and vertical synchronizing signals in the above-mentioned picture signal, the above-mentioned luminescence control circuit 301 operates to generate a synchronization signal for a scanning driver 306 and a data driver 307. Further, the luminescence control circuit 301 obtains the lighting rate of the pixel from the image data written in the above-mentioned memory 303, and operates to read the image data from the above-mentioned memory 303 according to the read-out signal R supplied from the luminescence control circuit 301.

In the preferred embodiment as shown in FIG. 21, the image data conversion table 304 is provided external to the luminescence control circuit 301, and the luminescence control circuit 301 refers to the image data conversion table 304 based on the above-mentioned lighting rate so as to perform an image data conversion process of changing the gradation value of the inputted picture signal based on the above-mentioned lighting rate as a result. In other words, the luminescence control circuit 301 extracts the image data whose gradation value is changed from the above-mentioned table 304 based on the above-mentioned lighting rate, and it operates so that the PLE control for controlling the emission brightness of each pixel 311 arranged at a display panel 310 to be described later may be realized based on the above-mentioned image data whose gradation value is changed.

Reference numeral 310 shown in FIG. 21 indicates the display panel in which a large number of pixels 311 each containing a light emitting element are arranged in a matrix pattern. Arranged orthogonally to each other at this display panel 310 are scanning lines 313 and data lines 314 which are respectively connected to the above-mentioned scanning driver 306 and the data driver 307. The pixels 311 containing the above-mentioned light emitting element are respectively arranged at these intersections. In addition, it is arranged that the voltage for lighting and driving the pixel is supplied to each of the above-mentioned pixels 311 from a power supply circuit 309 through a power supply line 316.

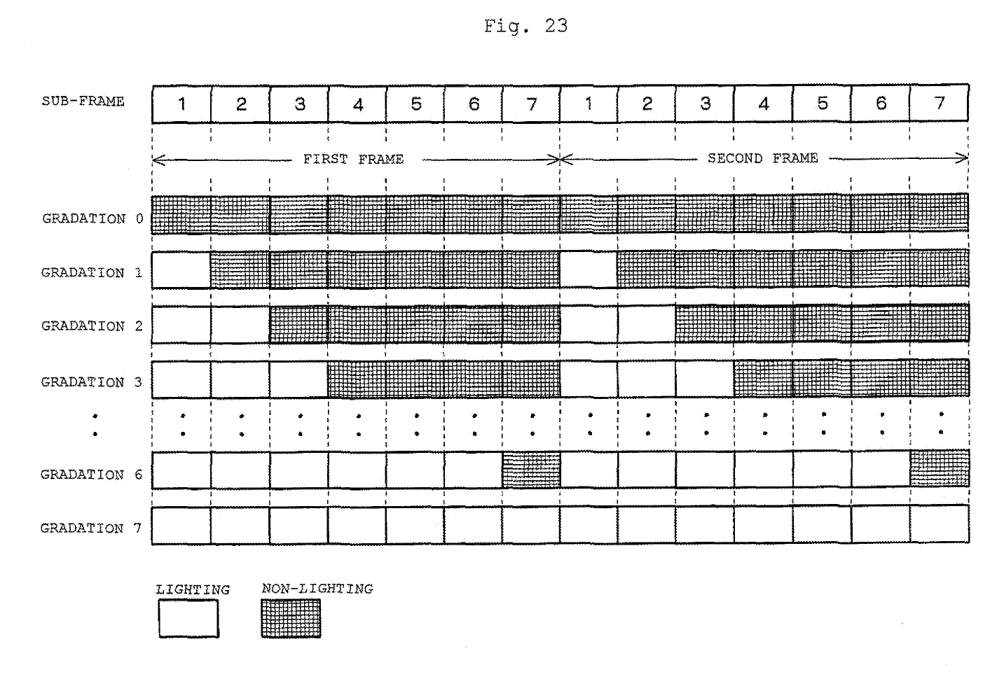

FIG. 22 shows a circuit structure corresponding to one pixel arranged at the above-mentioned display panel 310, and this shows the most fundamental pixel structure in the case of using the EL element as the light emitting element. This pixel 311 is arranged so that the data signal Vdata corresponding to the picture signal from the above-mentioned data driver 307 may be supplied to the source of TFT for control, i.e., the data write-in transistor Tr1, through the data line 314 arranged at the display panel.

It is arranged that the scanning signal Select (hereafter also referred to as write-in pulse) may be supplied to the gate of the above-mentioned data write-in transistor Tr1 through the scanning line 313 connected to the scanning driver 306. The drain of the above-mentioned data write-in transistor Tr1 is connected to the gate of the lighting and driving TFT i.e., the lighting and driving transistor Tr2 and also connected to one terminal of the capacitor C1 for holding electric charges.

Further, the source of the lighting and driving transistor Tr2 is arranged to be connected with the other terminal of the above-mentioned capacitor C1 and supplied with the drive voltage Vcc from the above-mentioned power supply circuit 309 via the power supply line 316. The drain of the above-mentioned lighting and driving transistor Tr2 is connected to the anode terminal of the organic EL element E1 as the light emitting element, and the cathode terminal of this organic EL element E1 is connected to the reference potential point (ground).

In addition, in the circuit structure of the pixel 311 as shown in FIG. 22, the data write-in transistor Tr1 is constituted by the n-channel type TFT, and the drive transistor Tr2 is constituted by the p-channel type TFT. As shown in FIG. 21, a large number of the thus arranged pixels 311 are arranged in a matrix pattern in the row and column directions so as to constitute the display panel 310.

In the structure of the pixel 311 as shown in FIG. 22, the write-in pulse Select as the scanning signal is supplied from the scanning driver 306 to the gate of the control transistor Tr1 in the address period. At this time, when the data signal Vdata supplied from the data driver 307 is the datum for causing the pixel to turn on, the current corresponding to the data signal Vdata flows into the capacitor C1 through the source and drain of the control transistor Tr1, and the capacitor C1 is charged.

Then, the charge voltage is supplied to the gate of the drive transistor Tr2, the transistor Tr2 causes the current corresponding to its gate voltage and the drive voltage Vcc supplied to the source to flow into the above-mentioned EL element E1, whereby the EL element E1 emits light.

If the application of the above-mentioned write-in pulse to the gate of the above-mentioned control transistor Tr1 is stopped, the transistor Tr1 is so-called cut off. However, the gate voltage of the drive transistor Tr2 is held by the electric charge accumulated in the capacitor C1, whereby the drive current to the EL element E1 is maintained.

Thus, the EL element E1 can continue the lighting state corresponding to the above-mentioned data signal Vdata in the period until the next address operation. Therefore, in the above-mentioned address period, according to the data signal Vdata supplied from the data driver 307, the lighting or turning-off of the pixel is controlled, to thereby realize the gradation control where the lighting period in a unit period of each pixel is controlled individually.

In the preferred embodiment as shown in FIGS. 21 and 22, in order to realize the above-mentioned PLE control, the gradation control means is employed which divides one frame (period) into a plurality of sub-frames to realize gradation control by controlling the lighting or the non-lighting of the pixel for each sub-frame and by summing the lighting periods of the pixel within one frame period.

FIG. 23 shows an example of the gradation control. In order to simplify the description in this example, a simple sub-frame method is shown in which one frame (period) is divided into seven sub-frames and eight gradations of “O“-”7” are expressed by simply summing the sub-frame periods. In this example, the data signal Vdata which controls the pixel to be lighting or non-lighting is supplied from the above-mentioned data driver 307 for each sub-frame period at the time of start of the sub-frame period.

When all of the first through seventh sub-frames that constitute one frame period are supplied with the data signal for controlling the pixel to be non-lighting, gradation “0” is realized as shown in FIG. 23. When all of the first through seventh sub-frames are supplied with the data signal for controlling the pixel to be “lighting”, gradation “7” is realized as shown in FIG. 23.

As already described, based on the lighting rate of the pixel, the above-mentioned luminescence control circuit 301 refers to the image data conversion table 304, and operates to perform an image data conversion process of extracting, from the table 304, image data whose gradation is low when the lighting rate is large. Thus, when the lighting rate is near 100%, it operates to reduce the gradation, which is based on the picture signal inputted into the luminescence control circuit 301, by n steps in gradation (n is an integer). Therefore, when the lighting rate is high, the lighting period in one frame period of the pixel is reduced, and the emission brightness of the pixel is inhibited.

As described above, since it operates so that the emission brightness of the pixel may be inhibited by controlling the gradation to be low when the lighting rate of the pixel is high, the maximum drive current supplied from the power supply circuit to the display panel is inhibited. Therefore, it is possible to solve the problem that the size of each component used for the power supply circuit and the whole power supply circuit are large.

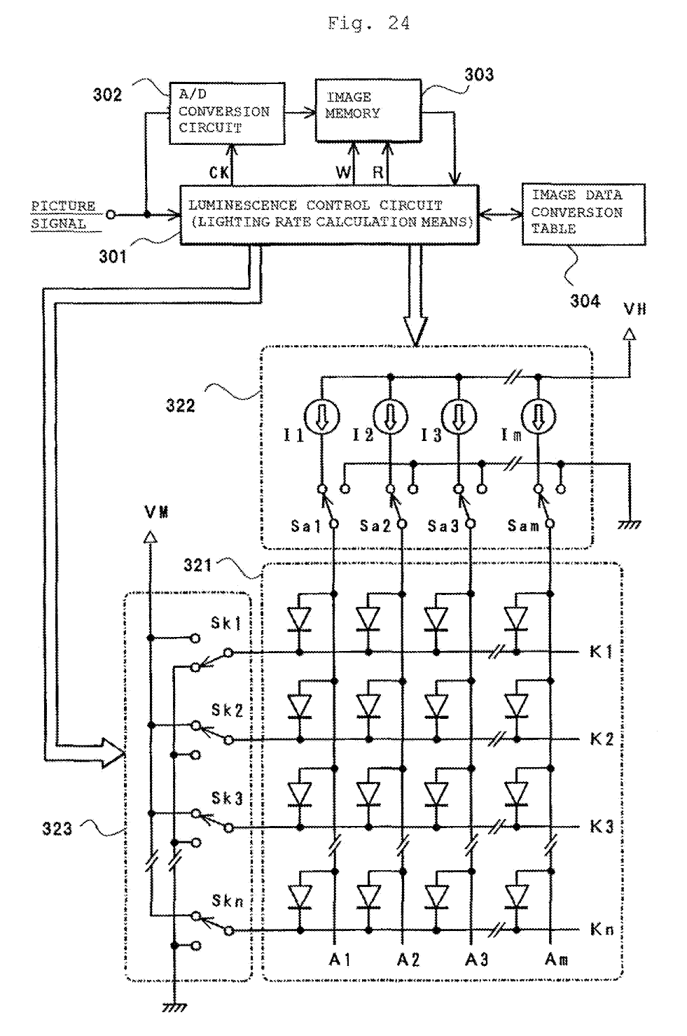

FIG. 24 shows a tenth preferred embodiment in the drive apparatus for the light-emitting display panel in accordance with the present invention, where a drive apparatus for a passive matrix type display panel is provided. A structure as shown with reference numerals 301-304 in FIG. 24 achieves the same function as the structure shown in FIG. 21, as already described. Therefore, the detailed description of these will not be repeated.

The anode lines A1-Am as m data lines are arranged vertically (in a column direction) at a display panel 321 as shown in FIG. 24. The cathode lines K1-Kn as n scanning lines are arranged horizontally (in a row direction). At each of their intersections (m×n positions in total), the organic EL element as the light emitting element as indicated by the symbol representative of a diode is connected and arranged between each anode line and scanning line. Each of the anode lines A1-Am is connected with an anode-line drive circuit 322 as the data driver, and each of the cathode lines K1-Kn is similarly connected with a cathode-line scanning circuit 323 as the scanning driver, thus being driven respectively.

The above-mentioned anode-line drive circuit 322 is provided with constant current sources I1-Im which operate by means of the drive voltage VH, and the drive switches Sa1-Sam. It operates such that the drive switches Sa1-Sam are connected to the above-mentioned constant current sources I1-Im side, so that current from the constant current sources I1-Im may be supplied to the individual EL elements arranged at the intersections where the anode lines intersect with the cathode lines. Further, when not supplying the current from the constant current sources I1-Im to the individual EL elements, the above-mentioned drive switches Sa1-Sam are arranged so that each of the above-mentioned anode lines can be connected to the ground potential as the reference potential point.

Further, the above-mentioned cathode-line scanning circuit 323 is provided with scanning switches Sk1-Skn corresponding to the respective cathode lines K1-Kn. The switches operate so that either of the reverse bias voltage source VM which functions as the non-scanning selection potential and prevents cross talk luminescence or the ground potential which functions as the scanning selection potential may be connected to the corresponding cathode line. Thus, the switches operate so that each of the above-mentioned EL elements may selectively be caused to emit light by connecting the constant current sources I1-Im to the desired anode lines A1-Am, while setting cathode lines as the reference potential point (ground potential) at predetermined time intervals.

In the preferred embodiment as shown in FIG. 24, the scanning synchronization signal is supplied from the luminescence control circuit 301 to the cathode-line scanning circuit 323, whereby the operation of setting each of the cathode lines K1-Kn as the ground potential (scanning selection potential) one by one is repeated. Further, in synchronization with the scanning synchronization signal, the image data for each scanning line are supplied from the luminescence control circuit 301 to the anode-line drive circuit 322. Therefore, each of the above-mentioned EL elements is turned on selectively, and the picture based on the picture signal is displayed on the display panel 321.

Also in the structure as shown in FIG. 24, a PWM gradation control method expressing eight gradations is employed by setting the lighting period in one scanning period as seven steps of periods, for example.

In other words, as with the example shown in FIG. 21, based on the lighting rate of the pixel, the luminescence control circuit 301 as shown in FIG. 24 refers to the image data conversion table 304 and operates to extract, from the table 304, the image data whose gradation is low when the lighting rate is large. Thus, when the lighting rate is near 100% (for example), it operates to reduce the gradation, which is based on the picture signal inputted into the luminescence control circuit 301, by n steps in gradation (n is an integer).

Accordingly, when the lighting rate is high, the lighting period in one frame period of the pixel is reduced, and the emission brightness of the pixel is inhibited. Therefore, also in the drive apparatus for the passive matrix type display panel, it is possible to obtain operational effects similar to those in the ninth preferred embodiment shown in FIGS. 21-23.

In addition, in the ninth and tenth preferred embodiments as described above, although the examples are shown in which the gradation control is carried out in eight steps, practical gradation control may suitably employ 32 steps, 64 steps etc., for example. Further, in the above description, although the examples are illustrated using the organic EL element as the light emitting element which constitutes each pixel, it is also possible to use another type of light emitting element whose emission brightness depends on the drive current.

What is clamed is:

1. A light-emitting display panel in which light emitting elements of a plurality of colors are arranged in a matrix pattern and each of said light emitting elements is selectively caused and driven to emit light based on a picture signal, said light-emitting display panel comprising:
an APL calculation means for calculating an average picture level (APL) from said picture signal, and a peak brightness control means for variably controlling peak brightness in said picture signal according to APL calculated by said APL calculation means, wherein
said APL calculation means is provided with a weighting means for weighting a picture signal of each color according to a light emitting current rate of each color at the time of displaying a gray scale,
wherein said APL calculation means is further provided with a second weighting means for weighting a picture signal of each color according to an emission brightness rate of each color at the time of displaying the gray scale, and
a selection means for choosing either said weighting means or said second weighting means causes said picture signal of each color to be subjected to the weighting by said weighting means or the weighting by said second weighting means.

2. A light-emitting display panel in which light emitting elements of a plurality of colors are arranged in a matrix pattern and each of said light emitting elements is selectively caused and driven to emit light based on a picture signal, said light-emitting display panel comprising:
an APL calculation means for calculating an average picture level (APL) from said picture signal, and a peak brightness control means for variably controlling peak brightness in said picture signal according to APL calculated by said APL calculation means, wherein
said APL calculation means is provided with a weighting means for weighting a picture signal of each color according to a light emitting power rate of each color at the time of displaying a gray scale,
wherein said APL calculation means is further provided with a second weighting means for weighting a picture signal of each color according to an emission brightness rate of each color at the time of displaying the gray scale, and
a selection means for choosing either said weighting means or said second weighting means causes said picture signal of each color to be subjected to the weighting by said weighting means or the weighting by said second weighting means.

3. A drive method for a light-emitting display panel in which light emitting elements of a plurality of colors are arranged in a matrix pattern and each of said light emitting elements is selectively caused and driven to emit light based on a picture signal, wherein
an average picture level (APL) is calculated from said picture signal by an APL calculation means, and
APL information data calculated by said APL calculation means are supplied as a control signal to a peak brightness control means, so as to perform variable control operation for peak brightness for variably controlling the peak brightness in said picture signal,
when calculating said average picture level, said APL calculation means selectively performs either first weighting operation for weighting a picture signal of each color according to a light emitting current rate of each color at the time of displaying a gray scale, or second weighting operation for weighting the picture signal of each color according to an emission brightness rate of each color at the time of displaying the gray scale.

4. A drive method for a light-emitting display panel in which light emitting elements of a plurality of colors are arranged in a matrix pattern and each of said light emitting elements is selectively caused and driven to emit light based on a picture signal, wherein
an average picture level (APL) is calculated from said picture signal by an APL calculation means, and
APL information data calculated by said APL calculation means are supplied as a control signal to a peak brightness control means, so as to perform variable control operation for peak brightness for variably controlling the peak brightness in said picture signal,
when calculating said average picture level, said APL calculation means selectively performs either first weighting operation for weighting a picture signal of each color according to a light emitting power rate of each color at the time of displaying a gray scale, or second weighting operation for weighting the picture signal of each color according to an emission brightness rate of each color at the time of displaying the gray scale.

5. A light-emitting display panel in which light emitting elements of a plurality of colors are arranged in a matrix pattern and each of said light emitting elements is selectively caused and driven to emit light based on a picture signal, said light-emitting display panel comprising:
an APL calculation means for calculating an average picture level (APL) from said picture signal, and a peak brightness control means for variably controlling peak brightness in said picture signal according to APL calculated by said APL calculation means, wherein
said APL calculation means is provided with a weighting means for weighting a picture signal of each color according to a light emitting current rate of each color at the time of displaying a gray scale,
wherein said APL calculation means is further provided with a second weighting means for weighting a picture signal of each color according to an emission brightness rate of each color at the time of displaying the gray scale, and
said picture signal of each color is subjected to weighting by said weighting means and weighting by said second weighting means.

6. A light-emitting display panel in which light emitting elements of a plurality of colors are arranged in a matrix pattern and each of said light emitting elements is selectively caused and driven to emit light based on a picture signal, said light-emitting display panel comprising:
an APL calculation means for calculating an average picture level (APL) from said picture signal, and a peak brightness control means for variably controlling peak brightness in said picture signal according to APL calculated by said APL calculation means, wherein
said APL calculation means is provided with a weighting means for weighting a picture signal of each color according to a light emitting power rate of each color at the time of displaying a gray scale,
wherein said APL calculation means is further provided with a second weighting means for weighting a picture signal of each color according to an emission brightness rate of each color at the time of displaying the gray scale, and
said picture signal of each color is subjected to weighting by said weighting means and weighting by said second weighting means.

7. A drive method for a light-emitting display panel in which light emitting elements of a plurality of colors are arranged in a matrix pattern and each of said light emitting elements is selectively caused and driven to emit light based on a picture signal, wherein
an average picture level (APL) is calculated from said picture signal by an APL calculation means, and
APL information data calculated by said APL calculation means are supplied as a control signal to a peak brightness control means, so as to perform variable control operation for peak brightness for variably controlling the peak brightness in said picture signal,
when calculating said average picture level, said APL calculation means performs first weighting operation for weighting a picture signal of each color according to a light emitting current rate of each color at the time of displaying a gray scale and second weighting operation for weighting the picture signal of each color according to an emission brightness rate of each color at the time of displaying the gray scale.

8. A drive method for a light-emitting display panel in which light emitting elements of a plurality of colors are arranged in a matrix pattern and each of said light emitting elements is selectively caused and driven to emit light based on a picture signal, wherein
an average picture level (APL) is calculated from said picture signal by an APL calculation means, and
APL information data calculated by said APL calculation means are supplied as a control signal to a peak brightness control means, so as to perform variable control operation for peak brightness for variably controlling the peak brightness in said picture signal,
when calculating said average picture level, said APL calculation means performs first weighting operation for weighting a picture signal of each color according to a light emitting power rate of each color at the time of displaying a gray scale and second weighting operation for weighting the picture signal of each color according to an emission brightness rate of each color at the time of displaying the gray scale.
